(19) United States
(12) Patent Application Publication
(10) Pub. No.: US 2019/0180227 A1
(43) Pub. Date: Jun. 13, 2019

(54) STOCK MANAGEMENT DEVICE, CUSTOMER TERMINAL, AND STOCK MANAGEMENT METHOD

(71) Applicant: NEC Corporation, Minato-ku, Tokyo (JP)

(72) Inventors: Hiromi YAMAGUCHI, Tokyo (JP); Shinji NAKADAI, Tokyo (JP)

(73) Assignee: NEC Corporation, Minato-ku, Tokyo (JP)

(21) Appl. No.: 16/326,975

(22) PCT Filed: Aug. 22, 2017
(86) PCT No.: PCT/JP2017/029873

§ 371 Date: Feb. 21, 2019

(30) Foreign Application Priority Data
Aug. 23, 2016 (JP) 2016-162551

(51) Int. Cl. G06Q 10/08; G06Q 30/06

(52) U.S. Cl. CPC G06Q 10/087; G06Q 30/0635; G06Q 30/0639

(57) ABSTRACT

Provide a stock management device enables a customer purchasing an item by online shopping to understand sales status of an item at a mobile sales vehicle. This stock management device is provided with: management means for managing stock information about stock of an item held by each of a plurality of mobile sales vehicles; first reception means for receiving sales information indicating an item sold at a storefront and state information indicating a state of the mobile sales vehicle; first transmission means for transmitting sales state information indicating whether or not the mobile sales vehicle is selling an item and the stock information, the sales state information being generated based on the state information; second reception means for receiving order information including information about an item ordered; and second transmission means for transmitting the order information to the mobile sales vehicle, wherein the management means updates the stock information.

### TECHNICAL FIELD

The present disclosure relates to a stock management device, a customer terminal, an item sales system, a stock management method, a display control method, and a recording medium.

### BACKGROUND ART

There are an increasing of doing online shopping to purchase an item through the Internet. Further, an item sales method called a mobile supermarket using a mobile sales vehicle has been proposed (NPL 1).

As a technology of combining the above, a technology of ordering, through a network, an item being sold by a mobile sales vehicle and purchasing the ordered item at a mobile sales vehicle is disclosed (PTL 1 and PTL 2).

Further, as a technology related to online shopping, for example, a method of supporting in-store picking of an item to be ordered is described in PTL 3.

### CITATION LIST

### Patent Literature

PTL 1: Japanese Unexamined Patent Application Publication No. 2011-221984
PTL 2: Japanese Unexamined Patent Application Publication No. 2008-123278
PTL 3: Japanese Unexamined Patent Application Publication No. 2009-151623

### Non Patent Literature

NPL 1: “Mobile Supermarket Tokushimaru,” [online], [retrieved on Jul. 13, 2016], retrieved from the Internet: <http://www.tokushimaru.jp/>

### SUMMARY OF INVENTION

### Technical Problem

Item purchase by online shopping takes at least several hours from ordering of an item to delivery to the purchaser, and therefore it takes a long time for actual delivery after ordering. However, in the case of item purchase by online shopping, for example, there is a benefit that a customer staying indoors can receive an item without going outdoors. Further, in item sale by a mobile sales vehicle, an item is displayed on a luggage carrier of the mobile sales vehicle as is the case with a common supermarket, and therefore a customer can actually take an item in hand and purchase the item at the mobile sales vehicle. Accordingly, for example, when a supermarket does not exist close to a customer and a mobile sales vehicle sells items close to the customer, there is a benefit that the customer can get an item to be purchased at a storefront of the mobile sales vehicle, without visiting a distant supermarket. A technology allowing a customer to acquire both such a benefit of using online shopping and such a benefit by using a mobile sales vehicle is being sought. In order to acquire the both benefits, the present inventors have found a method for unitarily managing stock of items being sold at a mobile sales vehicle and stock of items being sold on online shop. However, due to unitarily management of stock, when an item of which a customer using online shopping desires to purchase is being sold at a mobile sales vehicle, the item may possibly be purchased by a customer using the mobile sales vehicle. Consequently, a customer using online shopping may not be able to purchase the desired item after determining to purchase the item.

An object of the present disclosure is to provide a technology enabling a customer purchasing an item by online shopping to understand sales status of items at a mobile sales vehicle and also to have both a benefit of online shopping and a benefit of using a mobile sales vehicle.

### Solution to Problem

A stock management device according to one aspect of the present disclosure includes:

management means for managing stock information about stock of an item held by each of a plurality of mobile sales vehicles;

first reception means for receiving, from each of the plurality of mobile sales vehicles, sales information indicating an item sold at a storefront of the mobile sales vehicle and state information indicating a state of the mobile sales vehicle;

first transmission means for transmitting, to a customer terminal, sales state information indicating whether or not the mobile sales vehicle is selling an item at a storefront of the mobile sales vehicle and the stock information, the sales state information being generated based on the state information;

second reception means for receiving, from a customer terminal transmitting the stock information and the sales state information, order information including information about an item ordered based on the stock information and the sales state information; and

second transmission means for transmitting the order information to the mobile sales vehicle holding the ordered item included in the order information, wherein

the management means updates the stock information based on at least one of the sales information and the order information.

A customer terminal according to one aspect of the present disclosure includes:

reception means for receiving, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and

display control means for controlling a display device to display an ordering screen for receiving an order from a customer, the ordering screen being generated based on the stock information and the sales state information.

An item sales system according to one aspect of the present disclosure includes:

a stock management device;

an on-board device being loaded on each of a plurality of mobile sales vehicles and transmitting, to the stock management device, sales information indicating an item sold at a storefront of each of the plurality of mobile sales vehicle and state information indicating a state of the mobile sales vehicle; and

one or more customer terminals, wherein

the stock management device includes:
management means for managing stock information about stock of an item held by each of the plurality of mobile sales vehicles;
first reception means for receiving the sales information and the state information;
first transmission means for transmitting, to the customer terminal, sales state information indicating whether or not the mobile sales vehicle is selling an item at the storefront, the sales state information being generated based on the state information, and the stock information;
second reception means for receiving, from a customer terminal transmitting the stock information and the sales state information, order information including information about an item ordered based on the stock information and the sales state information; and
second transmission means for transmitting the order information to the on-board device on the mobile sales vehicle holding the ordered item included in the order information, wherein

the management means updates the stock information based on at least one of the sales information and the order information.

A stock management method according to one aspect of the present disclosure includes:

managing stock information about stock of an item held by each of a plurality of mobile sales vehicles;

receiving, from each of the plurality of mobile sales vehicles, sales information indicating an item sold at a storefront of the mobile sales vehicle;

receiving, from each of the plurality of mobile sales vehicles, state information indicating a state of the mobile sales vehicle;

transmitting, to a customer terminal, sales state information indicating whether or not the mobile sales vehicle is selling an item at the storefront, the sales state information being generated based on the state information, and the stock information;

receiving, from a customer terminal transmitting the stock information and the sales state information, order information including information about an item ordered based on the stock information and the sales state information; and

transmitting the order information to the mobile sales vehicle holding the ordered item included in the order information, wherein

updating the stock information based on at least one of the sales information and the order information.

A display control method according to one aspect of the present disclosure includes:

receiving, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and

controlling a display device to display an ordering screen for receiving an order from a customer, the ordering screen being generated based on the stock information and the sales state information.

A stock management method in an item sales system according to one aspect of the present disclosure, the item sales system including a stock management device, an on-board device being loaded on each of a plurality of mobile sales vehicles, and one or more customer terminals, the stock management method includes:

managing, by the stock management device, stock information about stock of an item held by each of the plurality of mobile sales vehicles;

transmitting, by the on-board device, to the stock management device, sales information indicating an item sold at a storefront of the mobile sales vehicle loaded with the on-board device and state information indicating a state of the mobile sales vehicle;

receiving, by the stock management device, the sales information;

receiving, by the stock management device, the state information;

transmitting, by the stock management device, to the customer terminal, sales state information indicating whether or not the mobile sales vehicle is selling an item at the storefront, the sales state information being generated based on the state information, and the stock information;

receiving, by the customer terminal, the stock information and the sales state information;

transmitting, by the customer terminal, to the stock management device, order information including information about an item ordered based on the stock information and the sales state information;

receiving, by the stock management device, the order information from the customer terminal;

transmitting, by the stock management device, the order information to the on-board device on the mobile sales vehicle holding the ordered item included in the order information; and

updating, by the stock management device, the stock information based on at least one of the sales information and the order information.

A computer program implementing, with a computer, the stock management device, the customer terminal, the item sales system, or the respective methods that are described above, and a computer-readable, non-transitory recording medium storing the computer program are also included in the scope of the present disclosure.

### Advantageous Effects of Invention

The present disclosure enables a customer purchasing an item by online shopping to understand sales status of an item at a mobile sales vehicle and also to have both a benefit of online shopping and a benefit of using a mobile sales vehicle.

### BRIEF DESCRIPTION OF DRAWINGS

FIG. 1 is a functional block diagram illustrating a functional configuration example of a stock management device according to a first example embodiment.

FIG. 2 is a flowchart illustrating an example of a processing flow in the stock management device according to the first example embodiment.

FIG. 3 is a functional block diagram illustrating a functional configuration example of a customer terminal communicating with the stock management device according to the first example embodiment.

FIG. 4 is a flowchart illustrating an example of a processing flow in the customer terminal communicating with the stock management device according to the first example embodiment.

FIG. 5 is a functional block diagram illustrating a functional configuration example of an item sales system including the stock management device according to the first example embodiment.

FIG. 6 is a flowchart illustrating an example of a processing flow in the item sales system including the stock management device according to the first example embodiment.

FIG. 7 is a block diagram illustrating a configuration example of an item sales system according to a second example embodiment.

FIG. 8 is a diagram for illustrating a use scene of the item sales system according to the second example embodiment.

FIG. 9 is a functional block diagram illustrating a functional configuration example of a stock management device in the item sales system according to the second example embodiment.

FIG. 10 is a diagram illustrating an example of stock information stored by a stock information storage unit according to the second example embodiment.

FIG. 11 is a diagram illustrating an example of customer information stored by a customer information storage unit according to the second example embodiment.

FIG. 12 is a functional block diagram illustrating a functional configuration example of an on-board device in the item sales system according to the second example embodiment.

FIG. 13 is a functional block diagram illustrating a functional configuration example of a customer terminal in the item sales system according to the second example embodiment.

FIG. 14 is a flowchart illustrating an example of a processing flow of updating stock information, based on sales information, in the item sales system according to the second example embodiment.

FIG. 15 is a flowchart illustrating an example of a flow of transmission processing of state information by the on-board device in the item sales system according to the second example embodiment.

FIG. 16 is a flowchart illustrating an example of a flow of sales processing of an item by online shopping in the item sales system according to the second example embodiment.

FIG. 17 is a flowchart illustrating an example of a flow of the sales processing of an item by online shopping in the item sales system according to the second example embodiment.

FIG. 18 is a diagram illustrating an example of an ordering screen displayed by a display unit.

FIG. 19 is a diagram illustrating another example of an ordering screen displayed by the display unit.

FIG. 20 is a diagram illustrating an example of a confirmation screen displayed by the display unit.

FIG. 21 is a diagram illustrating an example of an ordered items confirmation screen displayed by the display unit.

FIG. 22 is a diagram illustrating another example of an ordered items confirmation screen displayed by the display unit.

FIG. 23 is a functional block diagram illustrating a functional configuration example of an on-board device in an item sales system according to a third example embodiment.

FIG. 24 is a diagram illustrating an example of an ordering screen displayed by a display unit.

FIG. 25 is a diagram illustrating an example of a confirmation screen displayed by the display unit.

FIG. 26 is a flowchart illustrating an example of a processing flow in the item sales system according to the third example embodiment.

FIG. 27 is a functional block diagram illustrating a functional configuration example of a stock management device in an item sales system according to a modified example of the third example embodiment.

FIG. 28 is a diagram exemplarily illustrating a hardware configuration of a computer (information processing device) capable of implementing the respective example embodiments.

### EXAMPLE EMBODIMENT

### First Example Embodiment

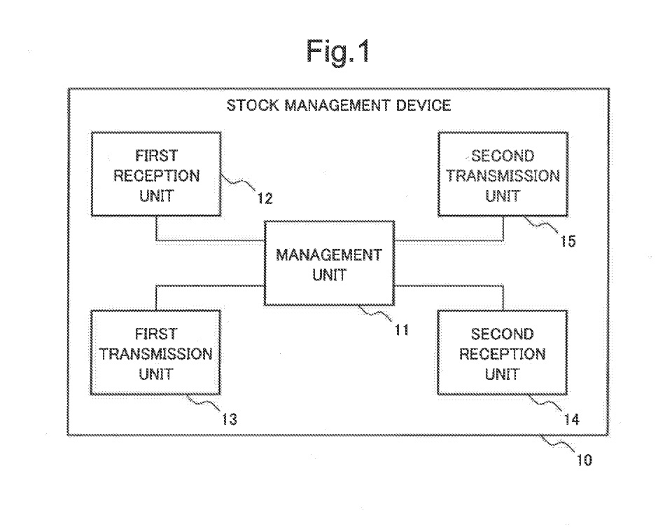

A first example embodiment of the present disclosure will be described with reference to drawings. A stock management device 10 managing stock information about stock of an item held by each of a plurality of mobile sales vehicles will be described in the present example embodiment. A mobile sales vehicle is a vehicle capable of moving to a predetermined location in accordance with a predetermined traveling route or in a predetermined area, and selling items loaded on a luggage carrier of the vehicle, at the destination. A mobile sales vehicle can also receive an order for items loaded on the vehicle, while opening a luggage carrier and selling items loaded on the luggage carrier, or through a network while moving. Then, based on the received order, the mobile sales vehicle delivers the item to a customer who ordered. As described above, a mobile sales vehicle sells items loaded on itself not only at its storefront but also through a network, and therefore selling items displayed at the storefront may compete with selling through a network. A technology of providing both a benefit of online shopping and a benefit of using a mobile sales vehicle even when items are in such a competition will be described in the present disclosure. FIG. 1 is a functional block diagram illustrating a functional configuration example of a stock management device 10 according to the present example embodiment. As illustrated in FIG. 1, the stock management device 10 according to the present example embodiment includes a management unit 11, a first reception unit 12, a first transmission unit 13, a second reception unit 14, and a second transmission unit 15.

The management unit 11 manages stock information about stock of an item held by each of a plurality of mobile sales vehicles. The stock information includes at least information (for example, an item name and an item identifier) for identifying an item held by each of the plurality of mobile sales vehicles and a quantity of the item. The management unit 11 manages stock information for each mobile sales vehicle. Stock information managed by the management unit 11 may be stored in a storage unit provided inside the stock management device 10 or may be stored in a storage device separate from the stock management device 10.

Further, the management unit 11 updates stock information, based on sales information received by the first reception unit 12 and/or order information received by the second reception unit 14.

The first reception unit 12 receives, from each of a plurality of mobile sales vehicles, sales information indicating an item sold at a storefront of the mobile sales vehicle and state information indicating a state of the mobile sales vehicle. The sales information includes at least information (for example, an item name and an item identifier) for identifying an item sold at the storefront of the mobile sales vehicle and a quantity of the item. The state information, for example, is generated based on at least one of a signal indicating a change in movement of or an operating state of a mobile sales vehicle, a signal indicating a change in an engine of the mobile sales vehicle or an operating state of the engine, and a signal indicating whether or not the mobile sales vehicle is open for business. A mobile sales vehicle is open for business represents a state of the mobile sales vehicle is selling items loaded on itself at its storefront. In other words, a mobile sales vehicle being open for business represents a state in which a customer using the mobile sales vehicle can purchase an item at the storefront of the mobile sales vehicle. The state information is generated, for example, by a state change being detected when a mobile sales vehicle starts moving from a stopped state, based on a signal indicating the detected state change. The first reception unit 12 provides the received sales information and state information to the management unit 11.

The first transmission unit 13 transmits, to a customer terminal, sales state information indicating whether or not a mobile sales vehicle is selling items at its storefront, the sales state information being generated based on state information, and stock information.

The second reception unit 14 receives order information including information about an ordered item from a customer terminal to which stock information and sales state information are transmitted by the first transmission unit 13. The ordered item is placed an order based on the stock information and the sales state information. The order information includes at least information for identifying a customer ordering an item, information (for example, an item name and an item identifier) for identifying the ordered item, the item being included in the stock information managed by the management unit 11, and a quantity of the item. The second reception unit 14 provides the received order information to the management unit 11.

The second transmission unit 15 transmits order information to a mobile sales vehicle holding an ordered item. Specifically, the second transmission unit 15 receives, from the management unit 11, information indicating a mobile sales vehicle holding an ordered item along with order information and transmits the order information to the mobile sales vehicle.

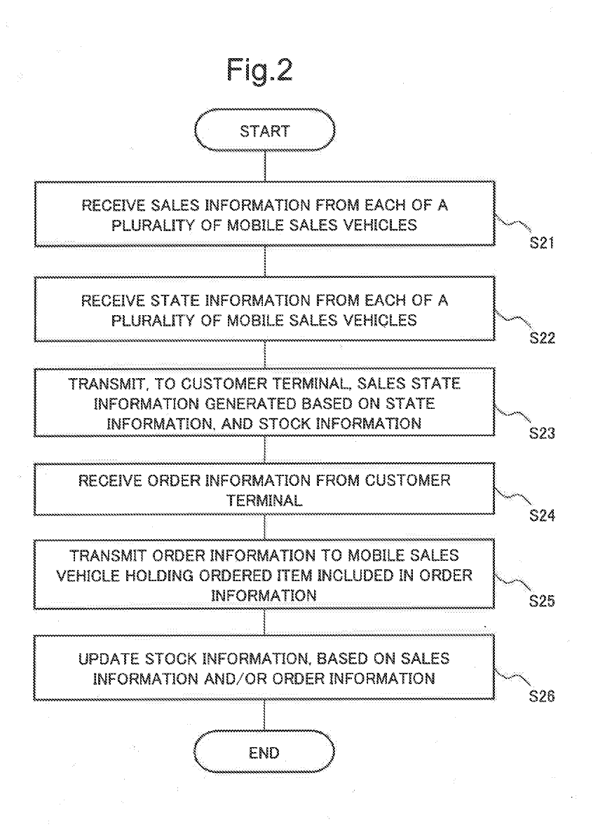

Next, a processing flow in the stock management device 10 according to the present example embodiment will be described with reference to FIG. 2. FIG. 2 is a flowchart illustrating an example of a processing flow in the stock management device 10 according to the present example embodiment. It is assumed in FIG. 2 that the management unit 11 in the stock management device 10 manages stock information about stock of an item held by a plurality of mobile sales vehicles, for each mobile sales vehicle.

As illustrated in FIG. 2, first, the first reception unit 12 in the stock management device 10 receives, from each of a plurality of mobile sales vehicles, sales information indicating an item sold at the storefront of the mobile sales vehicle (Step S21). Further, the first reception unit 12 receives, from each of a plurality of mobile sales vehicles, state information indicating a state of the mobile sales vehicle (Step S22).

After Step S22 ends, the first transmission unit 13 transmits, to a customer terminal, sales state information indicating whether or not a mobile sales vehicle is selling items at its storefront, the sales state information being generated based on state information, and the stock information (Step S23). The sales state information transmitted to the customer terminal by the first transmission unit 13 is generated for each mobile sales vehicle, based on state information about the mobile sales vehicle. Then, the first transmission unit 13 transmits, to the customer terminal, the sales state information generated for each mobile sales vehicle.

Then, the second reception unit 14 receives, from the customer terminal to which the stock information and the sales state information are transmitted by the first transmission unit 13 in Step S23, order information including information about an item ordered based on the stock information and the sales state information (Step S24).

Then, the second transmission unit 15 transmits the order information to a mobile sales vehicle holding the ordered item included in the order information received in Step S24 (Step S25). Step S21 may be performed after any of Steps S22 to S25 or may be performed at a time with any of Steps S22 to S25.

Further, when Step S21 and/or S25 ends, the management unit 11 updates the stock information, based on the sales information and/or the order information (Step S26). Specifically, when Step S21 ends, the management unit 11 updates stock information about stock held by a mobile sales vehicle transmitting sales information, based on the sales information. Further, when Step S25 ends, the management unit 11 updates stock information about stock held by a mobile sales vehicle to which the second transmission unit 15 transmitted the order information, based on the order information.

The above concludes the processing by the stock management device 10.

As described above, the management unit 11 updates stock information based on at least one of sales information received by the first reception unit 12 and order information received by the second reception unit 14. The stock management device 10 manages both stock for mobile sale by a mobile sales vehicle and stock for an online shop. Thus, the stock management device 10, for example, reflects stock for mobile sale in which items sold by mobile sale to stock for an online shop. Further, for example, when an order for an item is placed by an online shop, stock information about stock of items available for sale at a mobile sales vehicle is also updated. Consequently, both a customer using a mobile sales vehicle and a customer doing online shopping can confirm items in stock purchasable at the time. Accordingly, items held by a mobile sales vehicle can be sold both at the mobile sales vehicle and on an online shop.

Further, the second transmission unit 15 transmits order information to a mobile sales vehicle holding an ordered item included in the order information. Consequently, a driver of a mobile sales vehicle receiving the order information can deliver an item to a customer who ordered the item held by the mobile sales vehicle.

Further, the first transmission unit 13 transmits, to a customer terminal, sales state information indicating whether or not a mobile sales vehicle is selling items at the storefront, the sales state information being generated based on state information, and stock information. Consequently, a customer doing online shopping by use of a customer terminal can confirm stock information, and whether or not the mobile sales vehicle is selling the items included in the stock information is selling items at its storefront. Accordingly, the customer can do online shopping while understanding whether or not an item of which the customer desires to purchase is being also sold at the time at the storefront of the mobile sales vehicle.

Accordingly, the stock management device 10 according to the present example embodiment enables a customer purchasing an item by online shopping to understand sales status of the item at a mobile sales vehicle and also to have both a benefit of online shopping and a benefit of using a mobile sales vehicle.

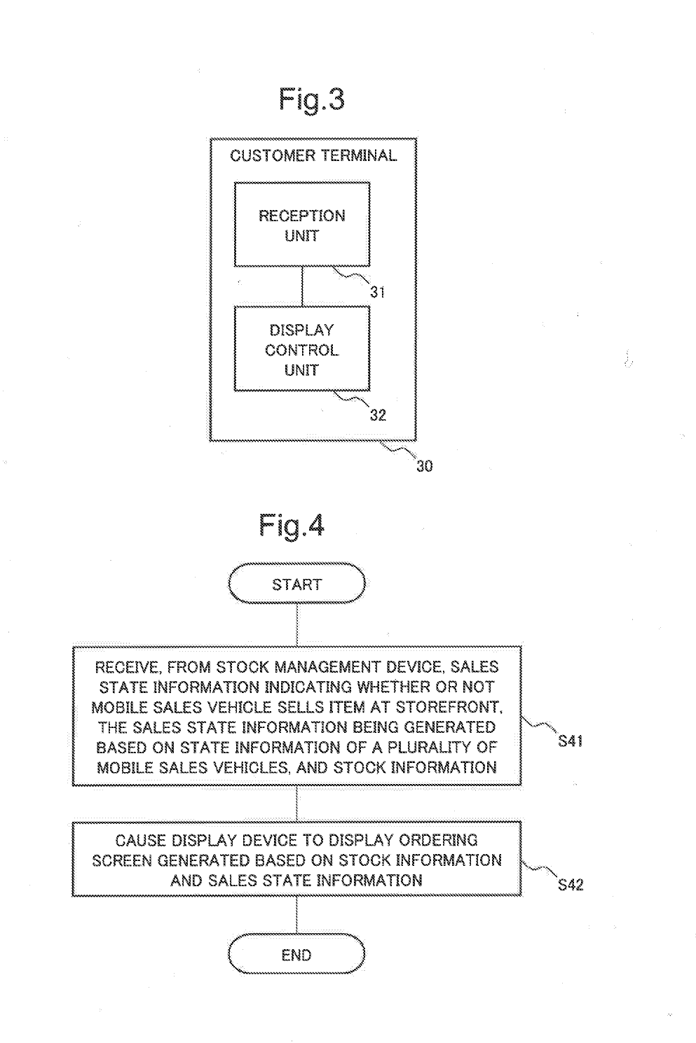

Next, a customer terminal communicating with the stock management device 10 will be described. FIG. 3 is a functional block diagram illustrating a functional configuration example of a customer terminal 30 communicating with the stock management device 10 according to the present example embodiment.

As illustrated in FIG. 3, the customer terminal 30 includes a reception unit 31 and a display control unit 32. The reception unit 31 receives, from the aforementioned stock management device 10, sales state information indicating whether or not a mobile sales vehicle is selling items at its storefront. The sales state information is generated based on state information indicating a state of each of a plurality of mobile sales vehicles. Further, the reception unit 31 receives stock information from the stock management device 10. The reception unit 31 provides the received sales state information and stock information to the display control unit 32.

The display control unit 32 controls a display device to display an ordering screen for receiving an order from a customer, the ordering screen being generated based on stock information and sales state information. At this time, when the sales state information indicates that a mobile sales vehicle sells items at its storefront of, it is preferable that the display control unit 32 gets an item included in stock information related to the mobile sales vehicle displayed on the ordering screen in a different manner from an item included in stock information related to another mobile sales vehicle.

Next, a processing flow in the customer terminal 30 will be described with reference to FIG. 4. FIG. 4 is a flowchart illustrating an example of a processing flow in a customer terminal 30 communicating with the stock management device 10 according to the present example embodiment.

First, the reception unit 31 receives, from the stock management device, sales state information indicating whether or not a mobile sales vehicle is selling items at its storefront, the sales state information being generated based on state information indicating a state of each of a plurality of mobile sales vehicles, and stock information (Step S41). Then, the display control unit 32 causes a display device to display an ordering screen for receiving an order from a customer, the ordering screen being generated based on the stock information and the sales state information (Step S42).

The above concludes the processing by the customer terminal 30.

As described above, the customer terminal 30 displays an ordering screen based on stock information and sales state information. Accordingly, a customer doing online shopping by use of the customer terminal 30 can confirm stock information, and whether or not the mobile sales vehicle selling the items included in the stock information is selling items at its storefront. Consequently, the customer can do online shopping while, for example, understanding whether or not an item of which the customer desires to purchase is being also sold at the time at the storefront of the mobile sales vehicle. Consequently, for example, when a customer doing online shopping prefers to securely get items that the customer desires to purchase, the customer can take a measure of ordering items not being sold at a storefront of a mobile sales vehicle at the time.

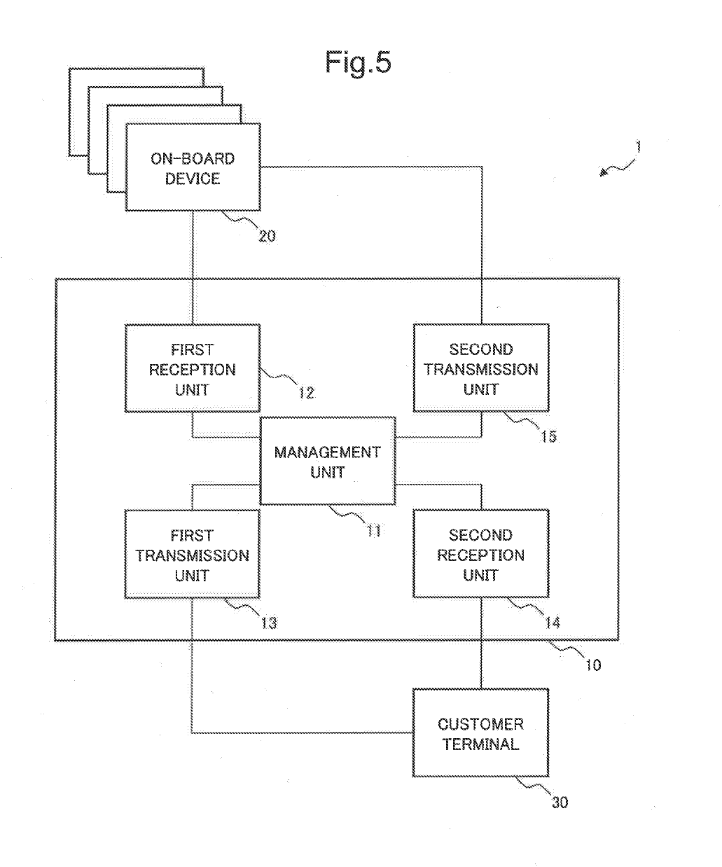

Further, an item sales system 1 including the stock management device 10 according to the present example embodiment will be described with reference to FIG. 5. FIG. 5 is a functional block diagram illustrating a functional configuration example of the item sales system 1 including the stock management device 10 according to the present example embodiment. As illustrated in FIG. 5, the item sales system 1 includes the stock management device 10, a plurality of on-board devices 20, and one or a plurality of customer terminals 30. The stock management device 10 included in FIG. 5 has a configuration similar to that of the stock management device 10 described by use of FIG. 1. Further, the customer terminal 30 included in FIG. 5 includes a function similar to that of the customer terminal 30 described by use of FIG. 3.

An on-board device 20 is loaded on each of a plurality of mobile sales vehicles and transmits, to the stock management device 10, sales information indicating an item sold at the storefront of each of the plurality of mobile sales vehicles. Further, an on-board device 20 transmits, to the stock management device 10, state information indicating a state of a mobile sales vehicle loaded with the on-board device 20. Then, a first reception unit 12 in the stock management device 10 receives the sales information and the state information.

A first transmission unit 13 in the stock management device 10 transmits, to a customer terminal 30, stock information and sales state information generated based on state information.

Further, a second reception unit 14 in the stock management device 10 receives order information transmitted from each customer terminal 30.

A management unit 11 in the stock management device 10 updates stock information based on at least one of sales information received by the first reception unit 12 and order information received by the second reception unit 14.

Further, a second transmission unit 15 transmits order information to an on-board device 20 on a mobile sales vehicle holding an ordered item included in the order information.

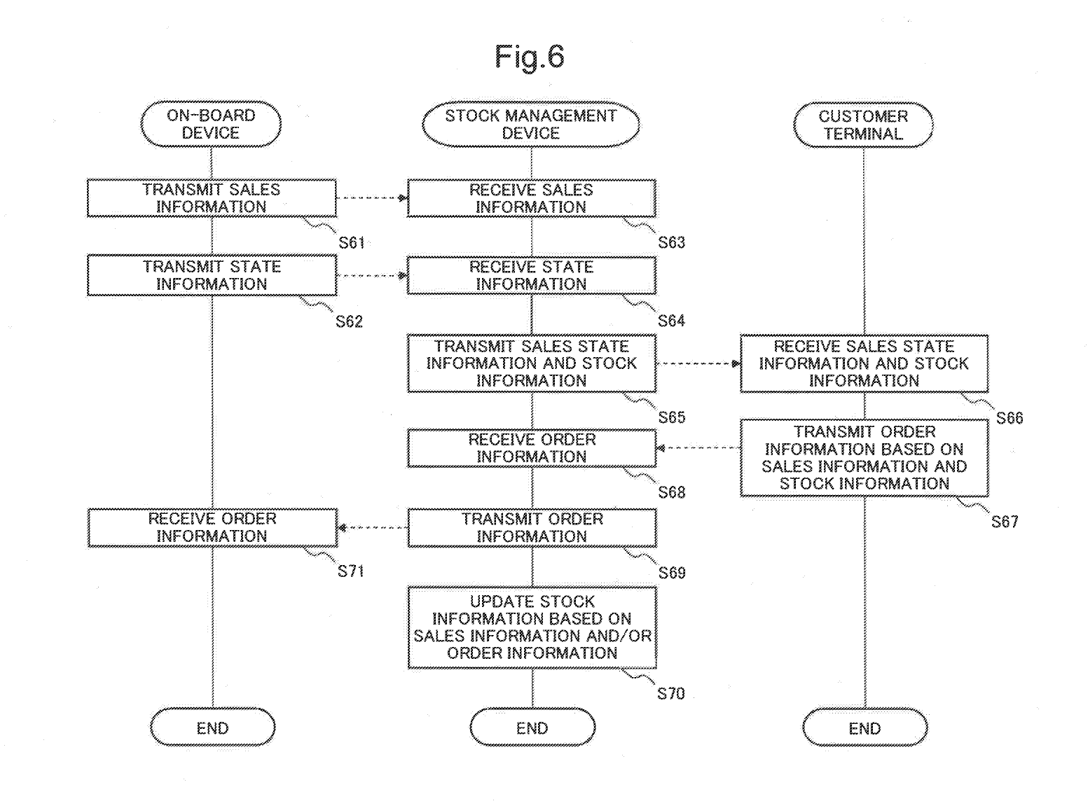

Next, a processing flow in the item sales system 1 including the stock management device 10 according to the present example embodiment will be described with reference to FIG. 6. FIG. 6 is a flowchart illustrating an example of a processing flow in the item sales system 1 including the stock management device 10 according to the present example embodiment. It is assumed in FIG. 6 that the management unit 11 in the stock management device 10 manages stock information about stock of an item held by a plurality of mobile sales vehicles, for each mobile sales vehicle. Further, in FIG. 6, processing by an on-board device 20 is described on the left, processing by the stock management device 10 at the center, and processing by a customer terminal 30 on the right; and a broken arrow between the respective processing steps represents a flow of primary information. An information flow is not limited to a direction of an arrow, and for example, an ACKnowledgement (ACK) may be transmitted in a direction reverse to the arrow.

As illustrated in FIG. 6, an on-board device 20 transmits, to the stock management device 10, sales information indicating an item sold at a storefront of a mobile sales vehicle loaded with the on-board device 20 (Step S61). Further, the on-board device 20 transmits, to the stock management device 10, state information indicating a state of the mobile sales vehicle (Step S62). Steps S61 and S62 may be performed at a time or may be performed in reverse order.

The first reception unit 12 in the stock management device 10 receives the sales information (Step S63). Further, the first reception unit 12 receives the state information (Step S64). Then, the first transmission unit 13 transmits, to a customer terminal 30, stock information and sales state information generated based on the state information (Step S65). The first transmission unit 13 may transmit the stock information and the sales state information separately. The sales state information may be transmitted every time the state information is received, as long as the transmission is performed after the stock information is transmitted.

Then, the customer terminal 30 receives, from the stock management device 10, the stock information and the sales state information (Step S66), and transmits, to the stock management device 10, order information including information about an item ordered based on the received stock information and sales state information (Step S67). Steps S61, S62, and S67 are performed asynchronously, and an order thereof is not particularly limited.

The second reception unit 14 in the stock management device 10 receives the order information from the customer terminal 30 (Step S68).

When Step S68 ends, the second transmission unit 15 transmits the order information to an on-board device 20 loaded on a mobile sales vehicle holding the ordered item included in the order information received by the second reception unit 14 in Step S68 (Step S69). Further, when Step S63 and/or S69 ends, the management unit 11 updates the stock information, based on the sales information and/or the order information (Step S70). Specifically, when updating the stock information based on the sales information, the management unit 11 updates, based on the sales information, stock information about stock held by the mobile sales vehicle transmitting the sales information. Further, when updating the stock information based on the order information, the management unit 11 updates, based on the order information, stock information about stock held by the mobile sales vehicle to which the order information is transmitted by the second transmission unit 15 in Step S69.

When Step S69 ends, the on-board device 20 receives the order information (Step S71).

In the item sales system 1, when an item is purchased at a mobile sales vehicle loaded with an on-board device 20, Step S61 is executed again. Further, when a customer starts shopping by use of a customer terminal 30, Step S66 is executed again.

Thus, the stock management device 10 executes the processing illustrated in the flowchart in FIG. 6 every time a customer purchases an item.

As described above, in the item sales system 1, the management unit 11 in the stock management device 10 updates stock information, based on sales information received by the first reception unit 12 and order information received by the second reception unit 14. Further, the second transmission unit 15 transmits order information to an on-board device 20 on a mobile sales vehicle holding an ordered item included in the order information. Consequently, the mobile sales vehicle loaded with the on-board device 20 can deliver the ordered item to a customer ordering the item.

Further, the stock management device 10 transmits stock information and sales state information to a customer terminal 30. Consequently, a customer using the customer terminal 30 can place an order, based on the stock information and the sales state information. Consequently, the customer can do online shopping while, for example, understanding whether or not an item of which the customer desires to purchase is being also sold at the time at the storefront of the mobile sales vehicle.

Accordingly, the item sales system 1 including the stock management device 10 according to the present example embodiment enables a customer purchasing an item by online shopping to understand sales status of the item at a mobile sales vehicle and also to have both a benefit of online shopping and a benefit of using a mobile sales vehicle.

### Second Example Embodiment

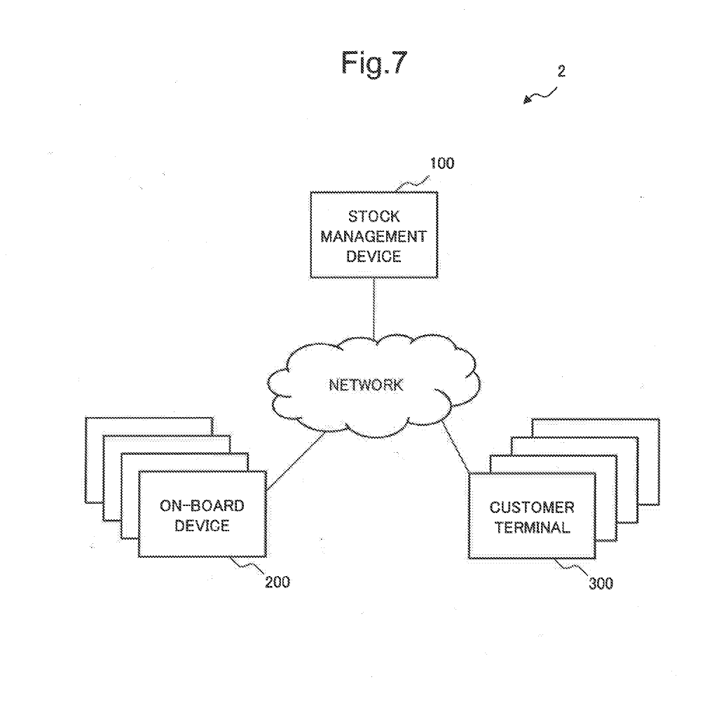

Next, a second example embodiment of the present disclosure based on the aforementioned first example embodiment will be described with reference to drawings. First, FIG. 7 illustrates a configuration example of an item sales system 2 according to the present example embodiment. As illustrated in FIG. 7, the item sales system 2 according to the present example embodiment includes a stock management device 100, a plurality of on-board devices 200, and one or a plurality of customer terminals 300. The stock management device 100 communicates with on-board devices 200 and customer terminals 300 through a network. A customer terminal 300 may be a mobile terminal or may be a desktop terminal.

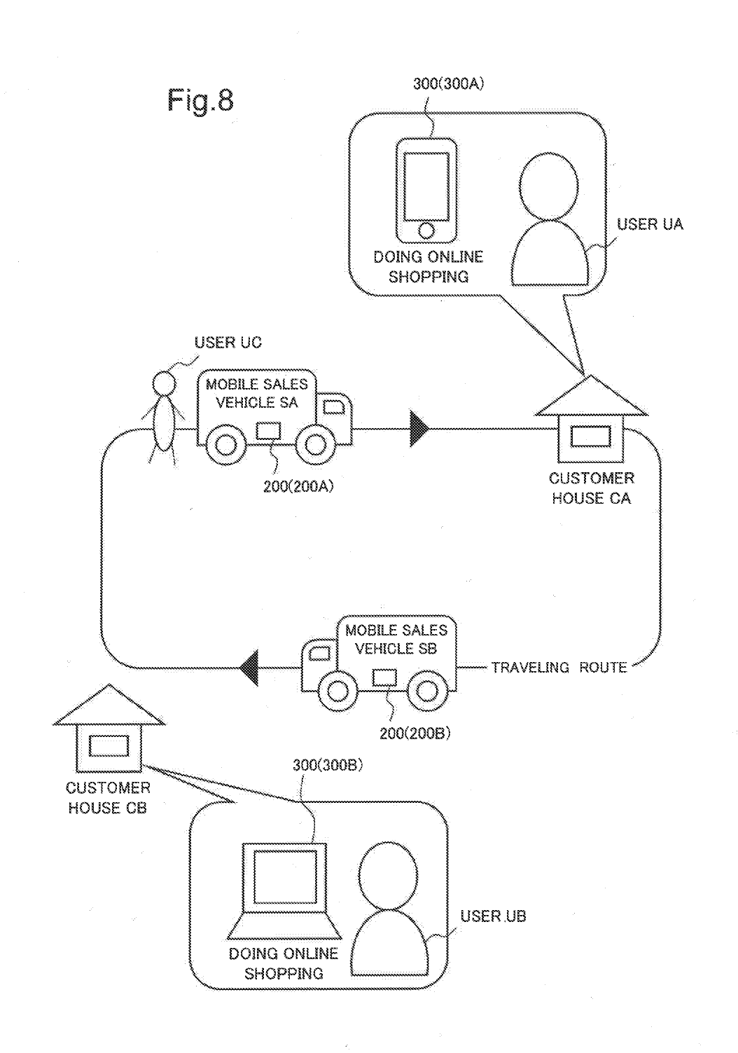

FIG. 8 is a diagram for illustrating a use scene of the item sales system 2 according to the present example embodiment. An on-board device 200 included in the item sales system 2 is a device loaded on each of a plurality of mobile sales vehicles. While FIG. 8 illustrates two mobile sales vehicles (SA, SB), a number of mobile sales vehicles may be three or more. Further, while an on-board device 200 loaded on the mobile sales vehicle SA is referred to as an on-board device 200A, and an on-board device 200 loaded on the mobile sales vehicle SB is referred to as an on-board device 200B, the devices are simply referred to as on-board devices 200 when the devices are not distinguished or referred to by a general name.

For example, each of the mobile sales vehicle SA and the mobile sales vehicle SB is a mobile-type supermarket traveling in accordance with a predetermined traveling route, stopping at a predetermined location, and selling a loaded item to a customer. The mobile sales vehicle may also be referred to as a mobile supermarket. Traveling routes according to which the plurality of mobile sales vehicles (SA, SB) travel may be identical, different, or partially overlapping one another.

It is assumed that a user UC is a customer using a mobile sales vehicle, according to the present example embodiment. It is further assumed that a user UA living in a customer house CA is a customer doing online shopping by use of a customer terminal 300A. It is further assumed that a user UB living in a customer house CB is a customer doing online shopping by use of a customer terminal 300B. The customer terminal 300A and the customer terminal 300B are simply referred to as customer terminals 300 when the terminals are not distinguished or referred to by a general name. The customer house CA and the customer house CB may be houses facing roads on the traveling routes of the mobile sales vehicles (SA, SB) or may be houses within a predetermined range from the traveling routes, respectively.

A store providing a service allowing a customer to do online shopping is hereinafter referred to as an online shop.

The item sales system 2 according to the present example embodiment provides both a customer using a mobile sales vehicle and a customer doing online shopping with benefits of using the respective means, by the stock management device 100 communicating with an on-board device 200 and a customer terminal 300.

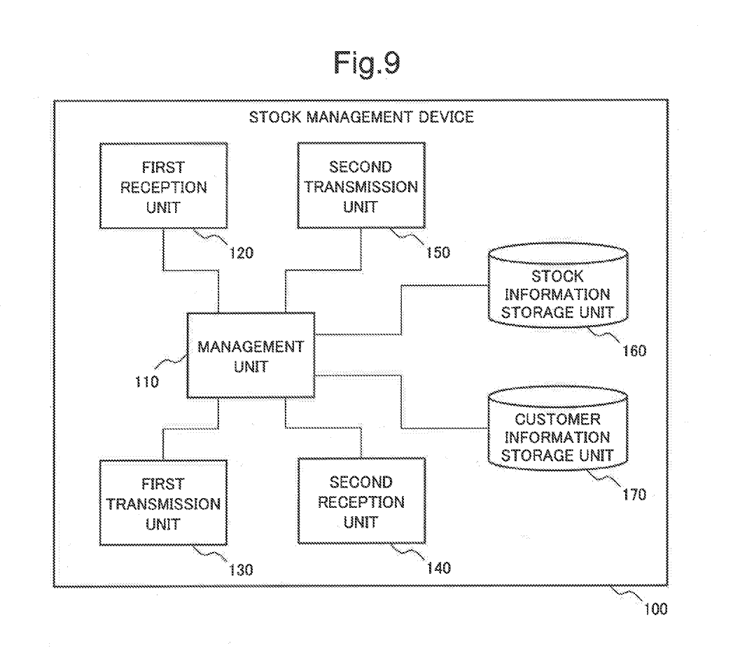

Next, a function of each device in the item sales system 2 according to the present example embodiment will be described in detail. FIG. 9 is a functional block diagram illustrating a functional configuration example of the stock management device 100 in the item sales system 2 according to the present example embodiment. As illustrated in FIG. 9, the stock management device 100 includes a management unit 110, a first reception unit 120, a first transmission unit 130, a second reception unit 140, a first transmission unit 140, a second transmission unit 150, a stock information storage unit 160, and a customer information storage unit 170.

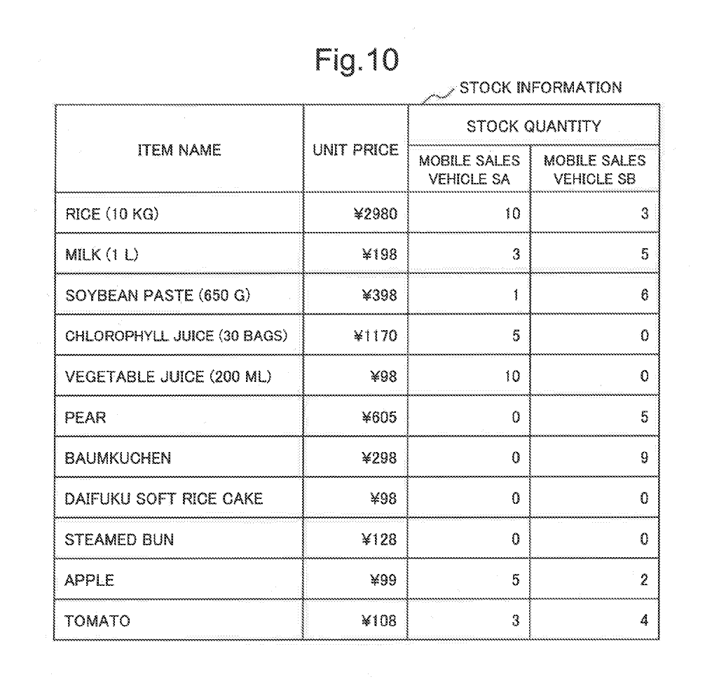

The stock information storage unit 160 stores stock information being information indicating stock of items in stock held by each of a plurality of mobile sales vehicles. The stock information stored by the stock information storage unit 160 will be described with reference to FIG. 10. FIG. 10 is a diagram illustrating an example of stock information stored by the stock information storage unit 160 according to the present example embodiment. The stock information includes at least an item name being information for identifying an item held by each of a plurality of mobile sales vehicles, and a quantity of an item represented by the item name for each mobile sales vehicle. The stock information may include a unit price, as illustrated in FIG. 10. Information included in the stock information is not limited to the above.

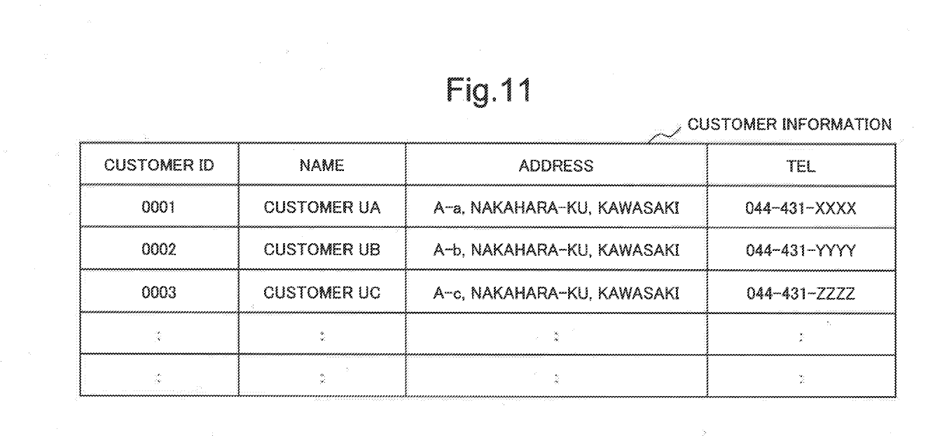

The customer information storage unit 170 stores customer information indicating information about a customer using a mobile sales vehicle and/or an online shop. The customer information stored by the customer information storage unit 170 will be described with reference to FIG. 11. FIG. 11 is a diagram illustrating an example of customer information stored by the customer information storage unit 170 according to the present example embodiment. The customer information includes a customer IDentifier (ID) for identifying a customer, a name of the customer, an address of the customer, and a telephone number of the customer. The customer information is not limited to the above and may include other information. Further, the customer information has only to include information by which a delivery address of an item can be identified. Further, for example, the customer information may include authentication information used for logging into an online shop. The customer information may be pre-registered when a service provided by the item sales system 2 is used. The registration method of the customer information is not particularly limited.

The stock information storage unit 160 and the customer information storage unit 170 may be implemented as separate storage units or may be implemented as the same storage unit. Further, the stock information storage unit 160 and the customer information storage unit 170 may be implemented as a storage device separate from the stock management device 100. Further, the stock information storage unit 160 and the customer information storage unit 170 may store stock information and customer information as databases, respectively.

The first reception unit 120 corresponds to the first reception unit 12 according to the first example embodiment. The first reception unit 120 receives from each of a plurality of mobile sales vehicles sales information indicating an item sold at its storefront. The sales information includes at least information (for example, an item name and an item identifier) for identifying an item sold at the storefront of the mobile sales vehicle and a quantity of the item. It is assumed below that the information for identifying an item is an item name. The first reception unit 120 provides the received sales information to the management unit 110 along with information (referred to as mobile sales vehicle information) indicating a mobile sales vehicle loaded with an on-board device 200 being a source of the sales information. The mobile sales vehicle information may be an identifier for identifying a mobile sales vehicle, a license plate number of the mobile sales vehicle, a vehicle identification number of the mobile sales vehicle, a model name of the mobile sales vehicle, or the like.

Further, the first reception unit 120 receives, from each of a plurality of mobile sales vehicles, state information indicating a state of the mobile sales vehicle. Details of the state information will be described later. The first reception unit 120 provides the received state information to the management unit 110.

The second reception unit 140 corresponds to the second reception unit 14 according to the first example embodiment. The second reception unit 140 receives, from a customer terminal 300, order information including information about an item ordered based on stock information transmitted to the customer terminal 300 and sales state information to be described later. The order information includes at least information for identifying a customer ordering an item, information (for example, an item name and an item identifier) for identifying the ordered item, the item being included in stock information managed by the management unit 110, and a quantity of the item. The second reception unit 140 provides the received order information to the management unit 110. The order information received by the second reception unit 140 may include delivery address information indicating a delivery address designated by a customer.

The management unit 110 corresponds to the management unit 11 according to the first example embodiment. The management unit 110 manages stock information stored in the stock information storage unit 160. Further, the management unit 110 manages customer information stored in the customer information storage unit 170. Further, the management unit 110 may manage sales information and order information. The sales information and the order information may be stored and managed in a storage unit in the stock management device 100.

Information about stock items loaded on a mobile sales vehicle is registered in the stock information managed by the management unit 110 before each of a plurality of mobile sales vehicles starts mobile sale and also before the item being purchasable by online shopping. Then, the management unit 110 updates the stock information every time an item is purchased by mobile sale, every time an item is purchased by online shopping, and every time an item is carried in.

Further, the management unit 110 acquires, from the stock information storage unit 160, stock information to be transmitted to a customer terminal and provides the acquired stock information to the first transmission unit 130. At this time, the stock information acquired by the management unit 110 may be stock information about stock held by each of the mobile sales vehicles allowing a customer to purchase the items on an online shop at present, or may be stock information about stock held by mobile sales vehicles positioned within a predetermined range from a customer terminal, based on a position of the customer terminal. The mobile sales vehicle allowing a customer to purchase an item on an online shop at present refers to, for example, a mobile sales vehicle capable of selling items on a luggage carrier at present, such as a mobile sales vehicle not being back in a garage, a mobile sales vehicle not all of items running out of stock, or a mobile sales vehicle not ending sale (not on the way back to a garage). Further, the stock information acquired by the management unit 110 may be, for example, stock information about stock held by a mobile sales vehicle positioned within a predetermined range from a delivery address when the delivery address is designated by a customer terminal. Further, the stock information acquired by the management unit 110 may be stock information about stock held by a mobile sales vehicle predesignated by a customer. Thus, the stock information acquired by the management unit 110 is not particularly limited.

Further, the management unit 110 receives state information from the first reception unit 120. The state information is generated based on at least one of a signal indicating a change in movement of or an operating state of a mobile sales vehicle, a signal indicating a change in an engine of the mobile sales vehicle or an operating state of the engine, and a signal indicating whether or not the mobile sales vehicle is open for business. The management unit 110 confirms whether or not the mobile sales vehicle is selling items based on the received state information. Then, the management unit 110 generates sales state information including the confirmation result (information indicating whether or not the mobile sales vehicle is selling items). For example, when state information indicates at least one state of a mobile sales vehicle being stopped, an engine of the mobile sales vehicle being stopped, and the mobile sales vehicle being open for business, the management unit 110 generates sales state information indicating that the mobile sales vehicle sells items. Further, for example, when state information indicates at least one state of a mobile sales vehicle moving, an engine of the mobile sales vehicle running, and the mobile sales vehicle being closed, the management unit 110 generates sales state information indicating that the mobile sales vehicle does not sell items. The management unit 110 provides the generated sales state information to the first transmission unit 130.

Further, the management unit 110 updates stock information based on at least one of sales information and order information. For example, when sales information is transmitted from the on-board device 200 on the mobile sales vehicle SA, the management unit 110 updates stock information about stock held by the mobile sales vehicle SA, based on the sales information. Further, for example, when a mobile sales vehicle holding an item included in order information is the mobile sales vehicle SA, the management unit 110 updates stock information about stock held by the mobile sales vehicle SA, based on the order information.

Further, the management unit 110 provides, to the second transmission unit 150, order information received by the second reception unit 140 along with information indicating a mobile sales vehicle holding an item included in the order information.

Further, when receiving sales information after the first transmission unit 130 transmits stock information to a customer terminal, the management unit 110 provides, to the first transmission unit 130, the sales information along with an instruction to transmit sales information to the customer terminal.

Further, when an item of which quantity in stock becomes zero by updating stock information exists, the management unit 110 may transmit, to a mobile sales vehicle holding the item the stock quantity of which is zero sellout information indicating that the item held by the mobile sales vehicle is sold out.

The first transmission unit 130 corresponds to the first transmission unit 13 according to the first example embodiment. The first transmission unit 130 receives stock information from the management unit 110. The first transmission unit 130 transmits the stock information to a customer terminal 300. When, for example, a browser is activated by a customer terminal 300, the first transmission unit 130 may generate a screen including stock information and transmit the generated screen to the customer terminal 300. Further, when, for example, an application is activated by a customer terminal 300, the first transmission unit 130 may transmit information including stock information to the customer terminal 300 in such a way that the application can display a screen including the stock information. When a customer terminal 300 can display a screen including stock information, the first transmission unit 130 may transmit stock information itself acquired by the management unit 110. It is preferable that a timing when the first transmission unit 130 transmits stock information to a customer terminal 300 be after detecting an operation of a customer for purchasing an item by use of the customer terminal 300. Detecting an operation of a customer for purchasing an item by use of a customer terminal 300 includes, for example, detecting, by a customer inputting login information to a customer terminal 300 for logging into an online shop, reception of the login information from the customer terminal 300 by the stock management device 100. Consequently, the customer using the customer terminal 300 can confirm stock information at a timing of logging into the online shop.

Further, the first transmission unit 130 may further transmit the updated stock information to a customer terminal 300 every time stock information is updated. Consequently, a customer using the customer terminal 300 can confirm latest stock information at updating.

Further, when receiving sales state information from the management unit 110, the first transmission unit 130 transmits the sales state information to a customer terminal 300. Further, when receiving sales information from the management unit 110, the first transmission unit 130 transmits the sales information to the customer terminal. The first transmission unit 130 may transmit the sales state information along with the stock information to the customer terminal 300.

The second transmission unit 150 corresponds to the second transmission unit 15 according to the first example embodiment. The second transmission unit 150 transmits order information to a mobile sales vehicle holding an ordered item included in the order information.

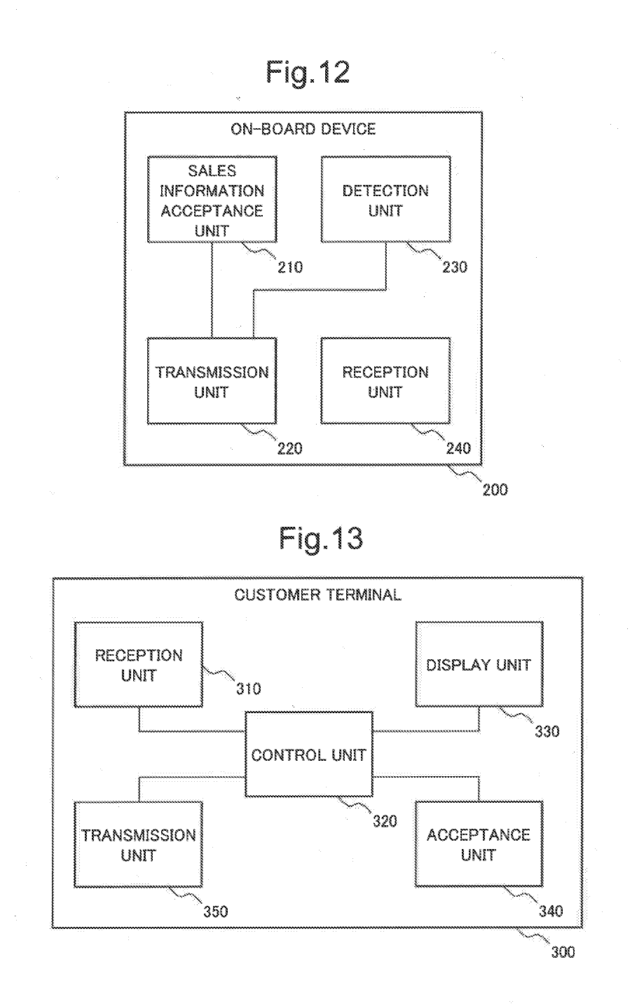

Next, a functional configuration of an on-board device 200 will be described with reference to FIG. 12. FIG. 12 is a functional block diagram illustrating a functional configuration example of an on-board device 200 in the item sales system 2 according to the present example embodiment. The on-board device 200 includes a sales information acceptance unit 210, a transmission unit 220, a detection unit 230, and a reception unit 240.

The sales information acceptance unit 210 accepts sales information including an item name of an item sold by a mobile sale (an item purchased by a customer) of a mobile sales vehicle loaded with the on-board device 200, and a quantity of the item. For example, the sales information acceptance unit 210 is implemented with a point of sales (POS) register. The sales information acceptance unit 210 provides the accepted sales information to the transmission unit 220.

The detection unit 230 detects a state change of or an operating state of a mobile sales vehicle loaded with an on-board device 200. Based on the detection result, the detection unit 230 generates state information indicating a state of the mobile sales vehicle. The detection unit 230 generates state information, for example, based on at least one of a signal indicating a change in movement of or an operating state of a mobile sales vehicle, a signal indicating a change in an engine of the mobile sales vehicle or an operating state of the engine, and a signal indicating whether or not the mobile sales vehicle is open for business.

For example, triggered by a state information transmission request being transmitted from the stock management device 100, the detection unit 230 detects an operating state of a mobile sales vehicle at that time and generates the detection result as state information. Further, the detection unit 230 may, for example, detect an operating state of a mobile sales vehicle at that time at predetermined intervals and generate the detection result as state information.

Further, for example, the detection unit 230 detects signals indicating a mobile sales vehicle starting to move from a stopped state and the mobile sales vehicle stopping from a moving state. Further, for example, the detection unit 230 detects a signal indicating an engine of a mobile sales vehicle stopping or the engine of the mobile sales vehicle being activated. Then, the detection unit 230 generates state information, based on the detection result.

Further, for example, the detection unit 230 detects a signal indicating a start of sale of an item or an end of sale of an item at a mobile sales vehicle. Specifically, for example, by detecting a signal indicating that a luggage carrier is opened or detecting a signal indicating that a POS register is opened, the detection unit 230 determines that a signal indicating a start of sale of an item at the mobile sales vehicle is detected. Further, for example, by detecting a signal indicating that a luggage carrier is closed or detecting a signal indicating that a POS register is closed, the detection unit 230 determines that a signal indicating an end of sale of an item at the mobile sales vehicle is detected.

Then, the detection unit 230 provides, to the transmission unit 220, state information indicating a 0045 state of the mobile sales vehicle, the state information being generated based on the detection result.

For example, when a state change detected by the detection unit 230 indicates a mobile sales vehicle starting to move from stopped state, the state change tells that a current state is moving. Accordingly, the detection unit 230 generates state information indicating the mobile sales vehicle moving and provides the state information to the transmission unit 220. Further, for example, when a state change detected by the detection unit 230 indicates a mobile sales vehicle stopping from a moving state, the detection unit 230 generates state information indicating the mobile sales vehicle stopped and provides the state information to the transmission unit 220. Further, for example, when a state change detected by the detection unit 230 indicates an engine of a mobile sales vehicle being stopped, the detection unit 230 generates state information indicating the engine being stopped and provides the state information to the transmission unit 220. Further, for example, when a state change detected by the detection unit 230 indicates an engine of a mobile sales vehicle being activated, the detection unit 230 generates state information indicating the engine running and provides the state information to the transmission unit 220. Further, for example, when a state change detected by the detection unit 230 indicates selling of an item being started at a mobile sales vehicle, the detection unit 230 generates state information indicating open for business and provides the state information to the transmission unit 220. Further, for example, when a state change detected by the detection unit 230 indicates selling of an item ending at a mobile sales vehicle, the detection unit 230 generates state information indicating closed and provides the state information to the transmission unit 220. A state change detected by the detection unit 230 is not limited to the above. Further, for example, state information may be positional information.

When receiving sales information from the sales information acceptance unit 210, the transmission unit 220 transmits the sales information to the stock management device 100. Further, when receiving state information from the detection unit 230, the transmission unit 220 transmits the state information to the stock management device 100.

The reception unit 240 receives order information transmitted from the stock management device 100. Consequently, a mobile sales vehicle loaded with the on-board device 200 receiving the order information can deliver an ordered item to a delivery address indicated by delivery address information, based on the order information.

Further, when sellout information is transmitted from the stock management device 100, the reception unit 240 may receive the sellout information. Consequently, a driver of a mobile sales vehicle loaded with the on-board device 200 or a customer using the mobile sales vehicle can understand that an item indicated by the sellout information is sold out.

Next, a functional configuration of a customer terminal 300 will be described with reference to FIG. 13. FIG. 13 is a functional block diagram illustrating a functional configuration example of a customer terminal 300 in the item sales system 2 according to the present example embodiment. As illustrated in FIG. 13, the customer terminal 300 includes a reception unit 310, a control unit (display control unit) 320, a display unit 330, an acceptance unit 340, and a transmission unit 350.

The reception unit 310 corresponds to the reception unit 31 according to the first example embodiment. The reception unit 310 receives stock information from the stock management device 100. The stock information has only to include information required for displaying information about stock of an item held by a mobile sales vehicle on the display unit 330 and may be, for example, the stock information itself stored in the stock information storage unit 160, part of the stock information, or processed stock information. The reception unit 310 provides the received stock information to the control unit 320.

Further, the reception unit 310 receives sales state information from the stock management device 100. The reception unit 310 provides the received sales state information to the control unit 320. The reception unit 310 may receive the sales state information along with the stock information.

Further, the reception unit 310 receives sales information from the stock management device 100. The reception unit 310 provides the received sales information to the control unit 320.

The display unit 330 displays a screen in accordance with an instruction by the control unit 320. For example, the display unit 330 is implemented with a liquid crystal display. The display unit 330 may be implemented with a display device separate from the customer terminal 300.

The acceptance unit 340 accepts an instruction from a user using the customer terminal 300. For example, the acceptance unit 340 accepts an instruction from a user input through an input device such as a mouse or a keyboard. The acceptance unit 340 provides the accepted instruction to the control unit 320.

The acceptance unit 340 and the display unit 330 may be integrally formed as a touch panel.

The control unit 320 corresponds to the display control unit 32 according to the first example embodiment. The control unit 320 controls the display unit 330 to display a screen based on the stock information and the sales state information that are received by the reception unit 310. When the sales state information indicates that a mobile sales vehicle sells items at its storefront, the control unit 320 may control the display unit 330 to display an item included in stock information related to the mobile sales vehicle in a mode different from an item included in stock information related to another mobile sales vehicle. Further, the control unit 320 provides, to the transmission unit 350, the order information including information about an item ordered by a customer.

Further, when receiving sales information from the reception unit 310, the control unit 320 causes the display unit 330 to display a screen based on the sales information. The screen will be described later by another drawing.

When receiving order information from the control unit 320, the transmission unit 350 transmits the order information to the stock management device 100.

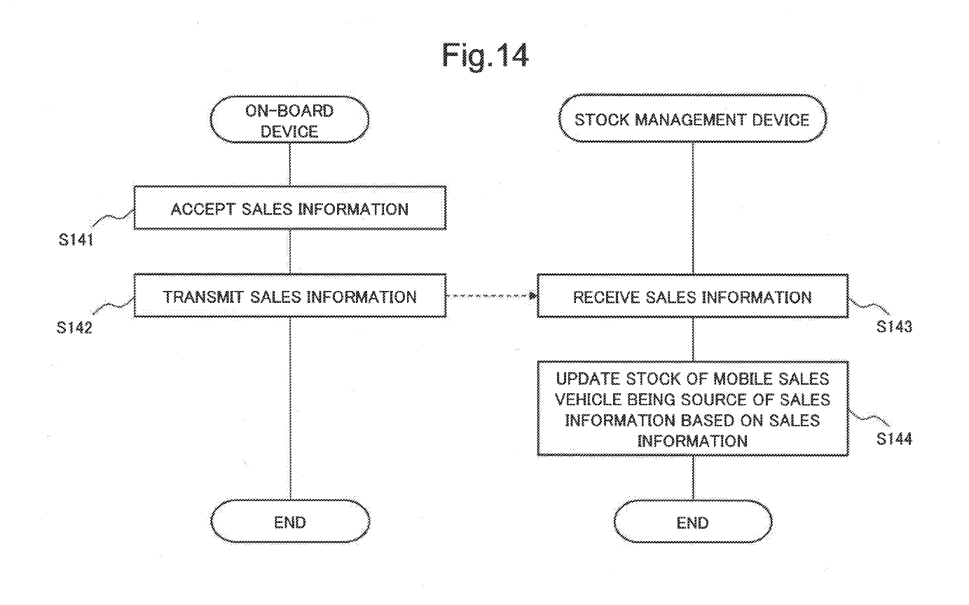

Next, processing of updating stock information, based on sales information, in the item sales system 2 will be described with reference to FIG. 14. FIG. 14 is a flowchart illustrating an example of a flow of the processing of updating stock information, based on sales information, in the item sales system 2 according to the present example embodiment.

It is assumed in FIG. 14 that the management unit 110 in the stock management device 100 manages stock information about stock of an item held by a plurality of mobile sales vehicles, for each mobile sales vehicle. Further, in FIG. 14, processing by an on-board device 200 is described on the left and processing by the stock management device 100 on the right; and a broken arrow between the respective processing steps represents a flow of primary information. An information flow is not limited to a direction of an arrow, and for example, an ACK may be transmitted in a direction reverse to the arrow.

First, by a mobile sales vehicle loaded with the on-board device 200 conducting mobile sale, the sales information acceptance unit 210 in the on-board device 200 accepts sales information including an item name of a sold item (an item purchased by a customer) and a quantity of the item (Step S141). Then, the transmission unit 220 transmits the sales information to the stock management device 100 (Step S142).

The first reception unit 120 in the stock management device 100 receives the sales information transmitted from the on-board device 200 (Step S143). The first reception unit 120 provides the sales information to the management unit 110 along with mobile sales vehicle information.

Based on the sales information provided from the first reception unit 120, the management unit 110 updates stock information about stock held by a mobile sales vehicle specified by the mobile sales vehicle information transmitted along with the sales information (Step S144).

The above concludes the processing of updating stock information, based on sales information.

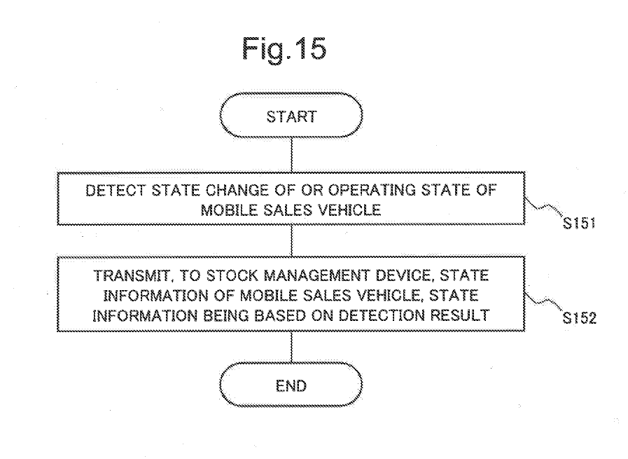

Next, transmission processing of state information by an on-board device 200 will be described with reference to FIG. 15. FIG. 15 is a flowchart illustrating an example of a flow of the transmission processing of state information by an on-board device 200 in the item sales system 2 according to the present example embodiment. The processing illustrated in FIG. 15 is performed asynchronously with the processing of updating stock information illustrated in FIG. 14.

As described in FIG. 15, the detection unit 230 detects a state change of or an operating state of a mobile sales vehicle (Step S151). Based on the detection result, the detection unit 230 generates state information about the mobile sales vehicle at the time of the detection and provides the state information to the transmission unit 220. Then, the transmission unit 220 transmits the state information to the stock management device 100 (Step S152).

The above concludes the transmission processing of state information by an on-board device 200.

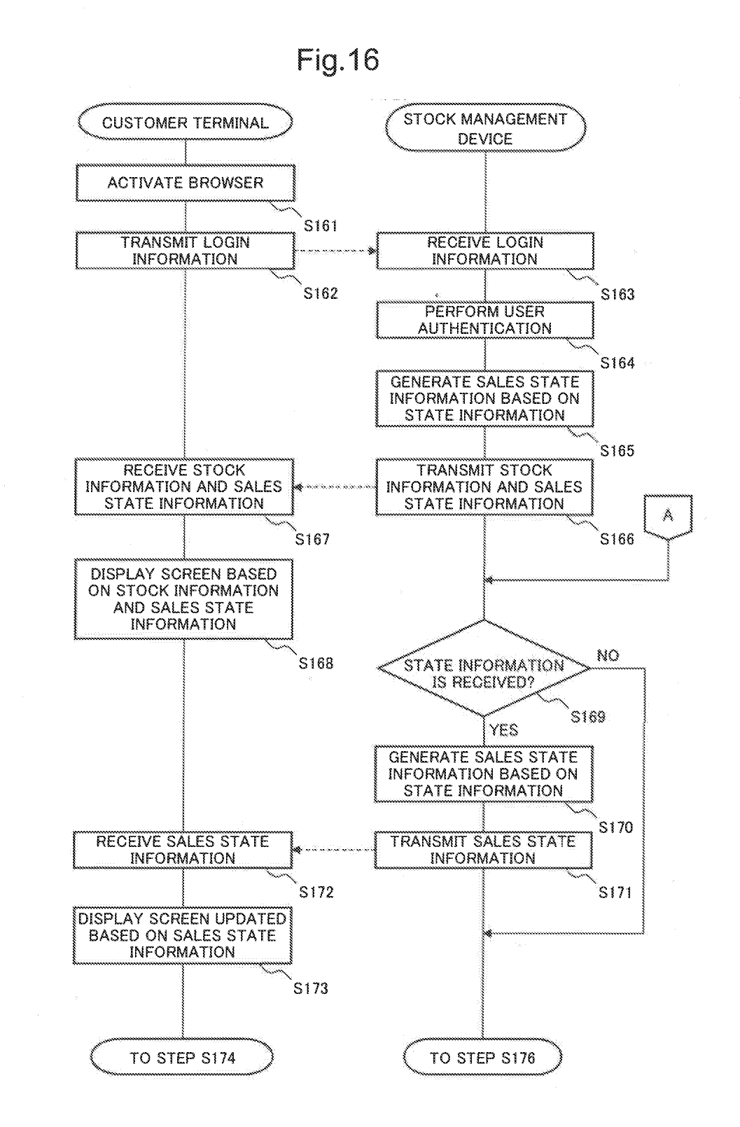

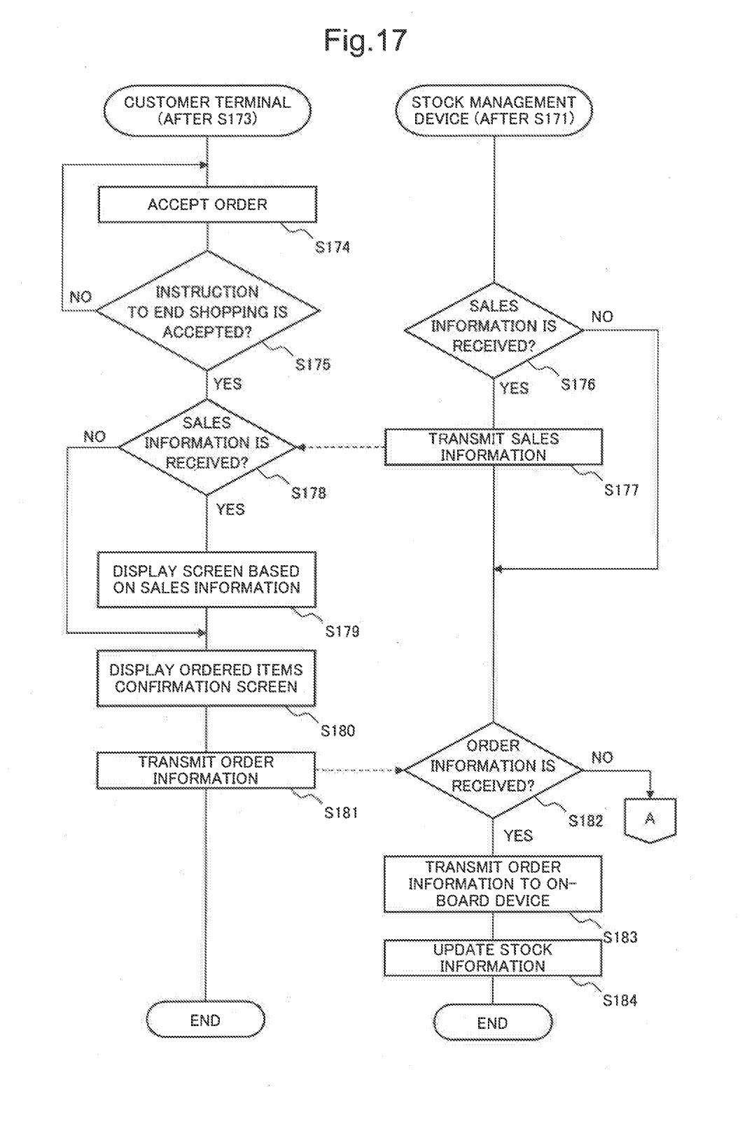

Next, sales processing of an item by online shopping in the item sales system 2 will be described with reference to FIGS. 16 and 17. FIGS. 16 and 17 are flowcharts illustrating an example of a flow of the sales processing of an item by online shopping in the item sales system 2 according to the present example embodiment. The processing illustrated in FIGS. 16 and 17 is performed asynchronously with the processing of updating stock information illustrated in FIG. 14 and the transmission processing of state information illustrated in FIG. 15.

In FIGS. 16 and 17, processing by a customer terminal 300 is indicated on the left, and processing by the stock management device 100 on the right. Further, a broken arrow between the respective processing steps in FIGS. 16 and 17 represents a flow of primary information. An information flow is not limited to a direction of an arrow, and for example, an ACK may be transmitted in a direction reverse to the arrow.

A user (customer) using a customer terminal 300 inputs an instruction to start online shopping into the customer terminal 300, and the acceptance unit 340 accepts a content of the instruction. For example, when an instruction to activate a browser is input in order to do online shopping, the control unit 320 activates the browser (Step S161). For example, when processing accepted by the acceptance unit 340 is an instruction to activate an application for doing online shopping, the control unit 320 activates the application installed on the customer terminal 300.

Then, the transmission unit 350 transmits information required for doing online shopping to the stock management device 100. For example, the transmission unit 350 transmits to the stock management device 100 login information, such as a customer ID and authentication information for logging into an online shop (Step S162). The login information may be input by a customer for each shopping.

When receiving the login information transmitted from the customer terminal 300 (Step S163), the second reception unit 140 in the stock management device 100 transmits the login information to the management unit 110. Then, the management unit 110 refers to the customer information storage unit 170 and performs user authentication (Step S164). The user authentication may use any method, and therefore description is omitted in the present example embodiment.

Subsequently, when the customer is authenticated, the management unit 110 acquires stock information stored in the stock information storage unit 160 and provides the acquired stock information to the first transmission unit 130. Further, when state information is received from an on-board device 200, the management unit 110 confirms whether or not a mobile sales vehicle from which the state information is received is selling items, based on the state information. Then, the management unit 110 generates sales state information indicating whether or not the mobile sales vehicle is selling items (Step S165). Then, the first transmission unit 130 transmits the sales state information along with the stock information acquired by the management unit 110 to the customer terminal 300 transmitting the login information to the stock management device 100 (Step S166). For example, it is assumed that the stock information includes information about stock held by the mobile sales vehicle SA and information about stock held by the mobile sales vehicle SB, as illustrated in FIG. 10, and only the mobile sales vehicle SA sells items at its storefront. In this case, the first transmission unit 130 transmits, to the customer terminal 300, stock information, and sales state information indicating that the mobile sales vehicle SA sells items and the mobile sales vehicle SB does not sell items. As described above, the first transmission unit 130 may transmit the stock information and the sales state information separately to the customer terminal 300. It is assumed in the following description that stock information and sales state information are transmitted to the customer terminal 300 from the first transmission unit 130. Further, a timing of transmission of the stock information by the first transmission unit 130 may be after the stock management device 100 receives a transmission instruction of the stock information from the customer terminal subsequently to performing the user authentication. The timing of transmission of the stock information by the first transmission unit 130 has only to be after detection of the customer starting shopping on an online shop by use of the customer terminal 300 (performing an operation for purchasing an item by use of the customer terminal 300) such as after the stock management device 100 receives the aforementioned transmission instruction of stock information. Further, the item sales system 2 may be configured not to perform user authentication.

Then, the reception unit 310 in the customer terminal 300 receives the stock information and the sales state information from the stock management device 100 (Step S167). Subsequently, the control unit 320 causes the display unit 330 to display a screen based on the received stock information and the sales state information (Step S168).

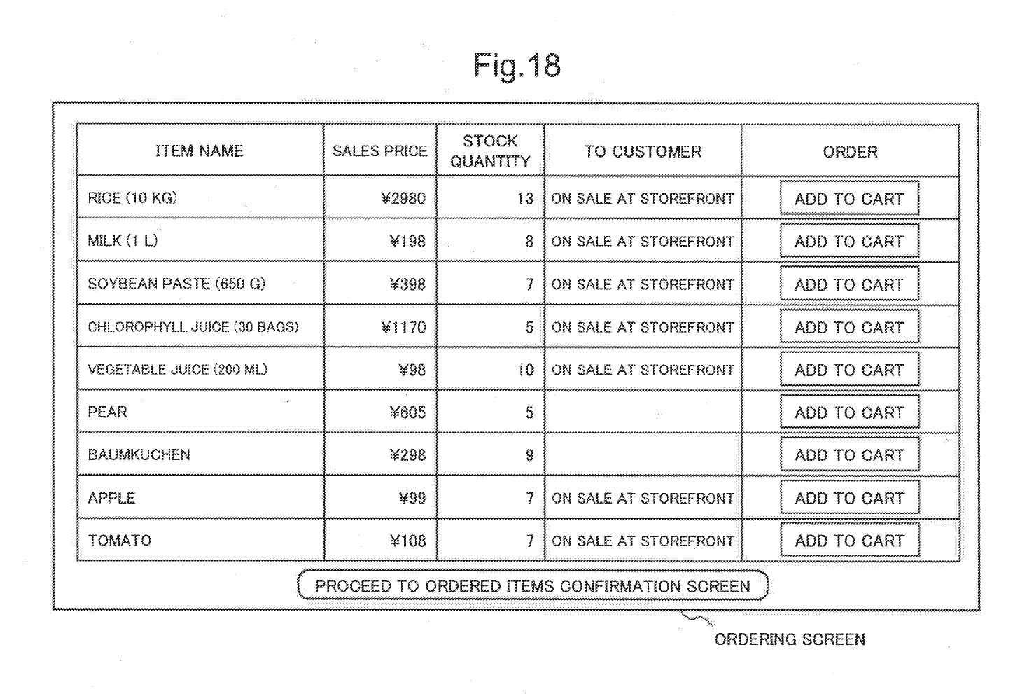

A screen (ordering screen) based on stock information and sales state information, the screen being displayed by the display unit 330, will be described with reference to FIG. 18. FIG. 18 is a diagram illustrating an example of an ordering screen displayed by the display unit 330 in a customer terminal 300 according to the present example embodiment.

It is assumed in the example in FIG. 18 that stock information about stock held by the mobile sales vehicle SA and about stock held by the mobile sales vehicle SB is transmitted to the customer terminal 300 from the stock management device 100. It is further assumed that the reception unit 310 receives sales state information indicating the mobile sales vehicle SA sells items and indicating the mobile sales vehicle SB does not sell items.

The ordering screen illustrated in FIG. 18 displays information about items, a total stock quantity of each of which held by the mobile sales vehicle SA and held by the mobile sales vehicle SB being one or more, out of the stock information illustrated in FIG. 10. Further, since the mobile sales vehicle SA is selling items at its storefront, “ON SALE AT STOREFRONT” indicating that an item is being sold at the storefront is displayed for an item held by the mobile sales vehicle SA. Specifically, “ON SALE AT STOREFRONT” is displayed for an item with an item name other than “PEAR” and “BAUMKUCHEN.” Thus, the control unit 320 causes the display unit 330 to display a screen (ordering screen) based on stock information and sales state information.

An “ADD TO CART” button in FIG. 18 is a button for accepting an instruction to add a relevant item to a cart on an online shop. In accordance with the instruction, the control unit 320 keeps information about the item added to the cart as cart information. The cart information includes information for identifying an item and a quantity of the item.

A “PROCEED TO ORDERED ITEMS CONFIRMATION SCREEN” button in FIG. 18 is a button for transition to a screen for confirming an item ordered by a customer. On the ordered items confirmation screen, a list of items added to the cart is displayed. Details of the ordered items confirmation screen will be described later. While the ordered items confirmation screen will be described as being displayed on a screen separate from the ordering screen in FIG. 18, the ordered items confirmation screen and the ordering screen may be displayed in separate frames on the same browser. Display forms of the ordering screen and the ordered items confirmation screen are not particularly limited.

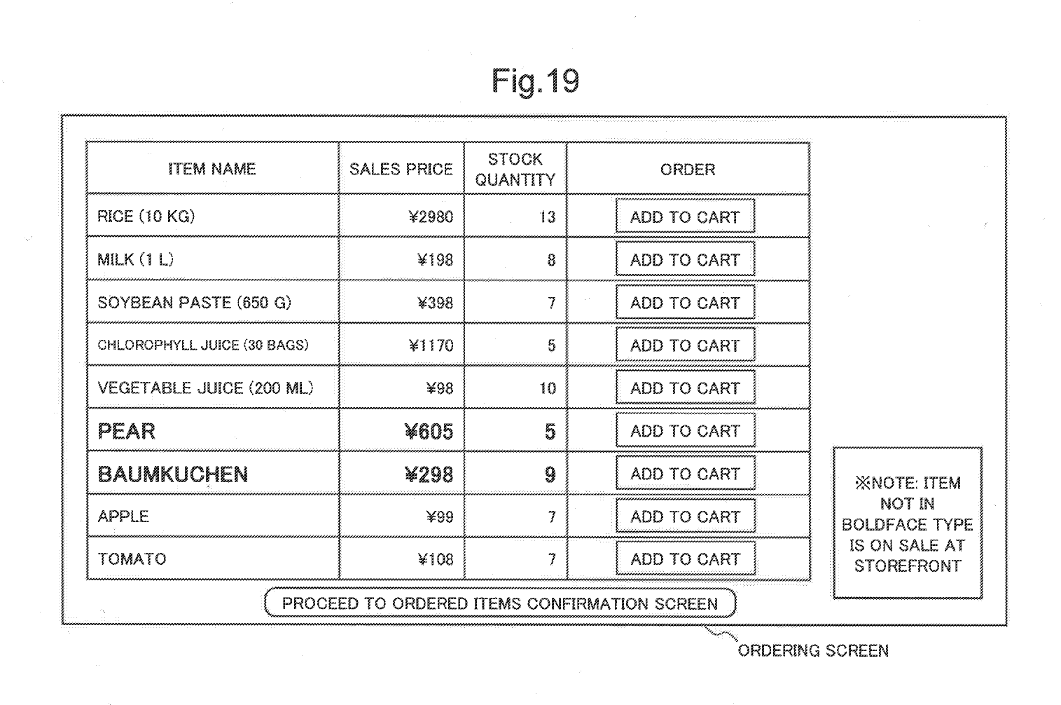

FIG. 19 is a diagram illustrating another example of an ordering screen displayed by the display unit 330 in the customer terminal 300 according to the present example embodiment. In FIG. 19, an item other than an item held by the mobile sales vehicle SA is displayed in boldface type. Thus, the customer terminal 300 displays an item being sold at a storefront differently from an item not being sold at a storefront. As described above, based on sales state information, the control unit 320 may express an item being sold at a storefront by displaying a character string such as “ON SALE AT STOREFRONT” as illustrated in FIG. 18 or may express a relevant item in a different manner from another item as illustrated in FIG. 19. For example, the control unit 320 may cause an item name of an item being sold at a storefront to blink, to be displayed in a color different from another character, or to be displayed in a font smaller than another character.

The control unit 320 may further get a quantity of an item being sold at a storefront displayed on the ordering screen. For example, “APPLE” is designated being sold at a storefront in FIG. 18. The quantity of apples being sold at the storefront is five which is held by the mobile sales vehicle SA. Accordingly, for example, the control unit 320 may get “5 ON SALE AT STOREFRONT” displayed on the ordering screen.

Thus, when sales state information indicates that the mobile sales vehicle SA is selling items at its storefront, the control unit 320 gets an item included in stock information related to the mobile sales vehicle SA displayed on the ordering screen in a different manner from an item included in stock information related only to the mobile sales vehicle SB. Consequently, the customer terminal 300 enables a customer ordering an item by use of the ordering screen to readily understand sales status of the item at a mobile sales vehicle.

Returning to the flow in FIG. 16, processing after Step S168 will be described. The first reception unit 120 in the stock management device 100 confirms whether or not state information is received from the on-board device 200 (Step S169), and when state information is not received (NO in Step S169), advances the processing to Step S176. When state information is received (YES in Step S169), the management unit 110 generates sales state information based on the state information (Step S170). Then, the first transmission unit 130 transmits the sales state information to the customer terminal 300 (Step S171).

Then, the reception unit 310 in the customer terminal 300 receives the sales state information (Step S172). Then, the control unit 320 causes the display unit 330 to display an ordering screen updated from the ordering screen displayed by the display unit 330 in Step S168, based on the sales state information (Step S173). For example, a case that the display unit 330 displays an ordering screen indicating the mobile sales vehicle SA is selling items as illustrated in FIG. 18 and the sales state information received in Step S172 indicates the mobile sales vehicle SA is not selling items at its storefront will be described. In this case, the control unit 320 causes the display unit 330 to display an ordering screen with the character string “ON SALE AT STOREFRONT” illustrated in FIG. 18 deleted. When the stock management device 100 does not receive state information, the customer terminal 300 skips the processing in Steps S172 and S173. Processing in and after Step S173 will be described with reference to FIG. 17.

Subsequently, by use of a screen (ordering screen) displayed based on the stock information and the sales state information, the customer orders an item. For example, when the customer depresses an “ADD TO CART” button illustrated in FIG. 18, the customer terminal 300 receives an order for an item by the customer, by the acceptance unit 340 accepting the depression of the button (Step S174). Subsequently, for example, when the “PROCEED TO ORDERED ITEMSCONFIRMATION SCREEN” button illustrated in FIG. 18 is depressed by the customer, the customer terminal 300 determines that an instruction to end the shopping is accepted, by the acceptance unit 340 accepting the depression of the button (YES in Step S175). The customer terminal 300 repeats Steps S174 and S175 until the acceptance unit 340 accepts the instruction to end the shopping.

Further, the first reception unit 120 in the stock management device 100 confirms whether or not sales information is received from the on-board device 200 (Step S176), and when sales information is not received (NO in Step S176), advances the processing to Step S182. When sales information is received (YES in Step S176), the first transmission unit 130 transmits the sales information to the customer terminal 300 (Step S177).

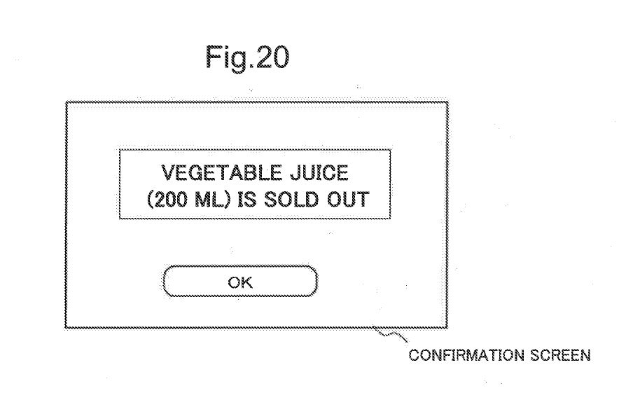

The reception unit 310 in the customer terminal 300 confirms whether or not sales information is received from the stock management device 100 (Step S178). When sales information is not received (NO in Step S178), the reception unit 310 advances the processing to Step S180. When sales information is received (YES in Step S178), the control unit 320 causes the display unit 330 to display a screen based on the sales information (Step S179). The screen (confirmation screen) based on the sales information, the control unit 320 causing the display unit 330 to display the screen in Step S179, will be described with reference to FIG. 20. For example, it is assumed that the customer adds “VEGETABLE JUICE (200 ML)” to the cart on the ordering screen illustrated in FIG. 18 and depresses “PROCEED TO ORDERED ITEMS CONFIRMATION SCREEN.” Then, it is assumed that the sales information received in Step S178 includes information indicating that all 10 each of “VEGETABLE JUICE (200 ML)” are purchased at a mobile sales vehicle. In this case, the stock has become zero during a period from a time when the ordering screen is displayed to a time when “PROCEED TO ORDERED ITEMS CONFIRMATION SCREEN” is depressed, and therefore the customer using the customer terminal 300 cannot purchase the “VEGETABLE JUICE (200 ML).” Accordingly, for example, the control unit 320 causes the display unit 330 to display a confirmation screen as illustrated in FIG. 20. Consequently, the customer terminal 300 enables the customer to understand that an item put into the cart by the customer is not purchasable. For example, the confirmation screen illustrated in FIG. 20 may be pop-up.

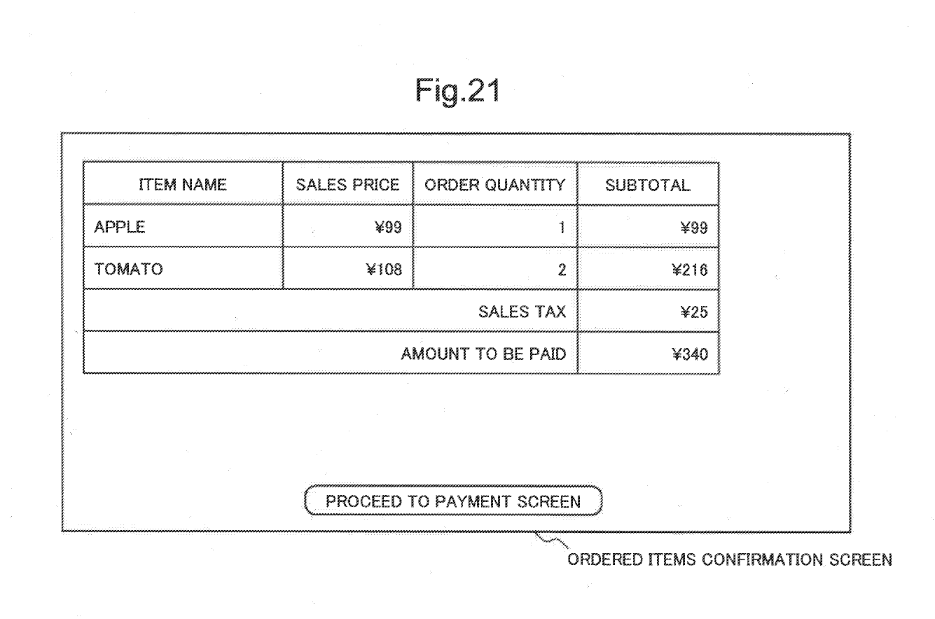

Subsequently, the control unit 320 causes the display unit 330 to display an ordered items confirmation screen (Step S180). The ordered items confirmation screen which the control unit 320 causes the display unit 330 to display in Step S180 will be described with reference to FIG. 21. For example, it is assumed that the customer adds “APPLE” and “TOMATO” to the cart on the ordering screen illustrated in FIG. 18. Based on kept cart information, the control unit 320 displays the ordered items confirmation screen. For example, a case that the customer adds “APPLE,” “TOMATO,” and “VEGETABLE JUICE (200 ML)” to the cart on the ordering screen illustrated in FIG. 18, and “VEGETABLE JUICE (200 ML)” is not purchasable is assumed. In this case, after displaying the confirmation screen in FIG. 20, the control unit 320 may display, on the display unit 330, an ordered items confirmation screen displaying only a purchasable item.

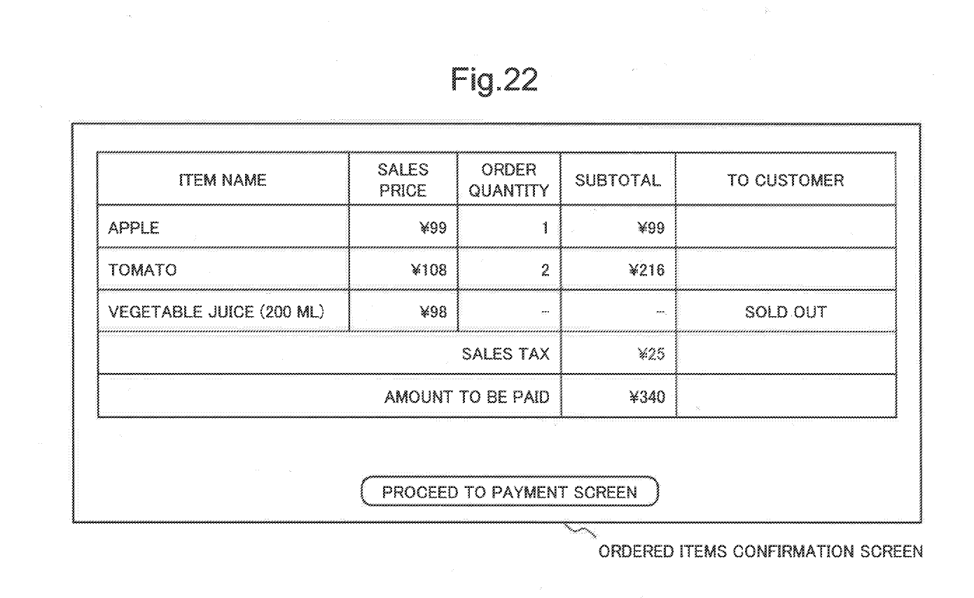

Further, in the case described above, after displaying or not displaying the confirmation screen in FIG. 20, the control unit 320 may display an ordered items confirmation screen as illustrated in FIG. 22 on the display unit 330. The ordered items confirmation screen illustrated in FIG. 22 includes information about an item becoming sold out, based on sales information.

A “PROCEED TO PAYMENT SCREEN” button in FIGS. 21 and 22 is a button for transition to a screen for making payment. A payment method can be selected on the payment screen. The payment method is not particularly limited, and therefore description is omitted in the present example embodiment. When an instruction to make payment is input, the acceptance unit 340 accepts the instruction. Then, in accordance with the instruction to make payment, the control unit 320 provides information (information about an item included in the ordered items confirmation screen) kept as cart information and information for identifying the customer to the transmission unit 350 as order information. Subsequently, the transmission unit 350 transmits the order information to the stock management device 100 (Step S181).

The second reception unit 140 in the stock management device 100 determines whether or not order information is received from the customer terminal 300 (Step S182). When order information is not received (NO in Step S182), the stock management device 100 returns the processing to Step S169 and repeats Steps S169 to S171, S176, and S177 until order information is received.

When order information is received (YES in Step S182), the second transmission unit 150 transmits the order information to a mobile sales vehicle holding an item included in the order information and delivering the item, based on the order information received by the second reception unit 140 (Step S183). Further, the management unit 110 updates the stock information based on the order information (Step S184). Step S183 may be performed before Step S184 or may be performed at a time with Step S184.

Since the reception unit 240 in the on-board device 200 receives the order information transmitted from the stock management device 100 by Step S183 being performed, a mobile sales vehicle loaded with the on-board device 200 can deliver the item to the customer, based on the order information.

The above concludes the sales processing of an item by online shopping, by the item sales system 2.

As described above, the management unit 110 in the stock management device 100 in the item sales system 2 according to the present example embodiment manages stock information about items held by each of a plurality of mobile sales vehicles. Further, the first reception unit 120 receives sales information indicating an item sold at the mobile sales vehicle from an on-board device 200 loaded on each of the plurality of mobile sales vehicles. Further, the first reception unit 120 receives state information indicating a state of a mobile sales vehicle from an on-board device 200 loaded on each of the plurality of mobile sales vehicles. Further, the second reception unit 140 receives, from a customer terminal 300, order information including information about an item ordered based on stock information transmitted to the customer terminal 300. Additionally, the second transmission unit 150 transmits order information to an on-board device 200 loaded on a mobile sales vehicle holding the ordered item included in the order information. Consequently, the mobile sales vehicle loaded with the on-board device 200 receiving the order information can deliver the ordered item to a customer ordering the item.

Further, the stock management device 100 transmits stock information and sales state information to a customer terminal 300. Consequently, a customer using the customer terminal 300 can place an order, based on the stock information and the sales state information. Consequently, the customer can do online shopping while, for example, understanding whether or not items of which the customer desires to purchase are being also sold at a storefront of the mobile sales vehicle at that point.

Further, since an on-board device 200 receives order information, a driver of a mobile sales vehicle loaded with the on-board device 200 can understand items available for actual sale out of items held by the mobile sales vehicle.

Accordingly, the item sales system 2 according to the present example embodiment enables a customer purchasing an item by online shopping to understand sales status of the item at a mobile sales vehicle and also to have both a benefit of online shopping and a benefit of using a mobile sales vehicle.

An on-board device 200 according to the present example embodiment may have a function of measuring a current position of a mobile sales vehicle loaded with the on-board device 200. Specifically, for example, an on-board device 200 may receive positional information by use of the Global Positioning System (GPS) and measure, from the received positional information, a current position of a mobile sales vehicle loaded with the on-board device 200. Then, the on-board device 200 may transmit, to the stock management device 100, information (current position information) indicating a current position being the positioning result.

Then, the stock management device 100 may have a function of receiving current position information and specifying a mobile sales vehicle delivering an item by use of the current position information. For example, based on order information received by the second reception unit 140, the stock management device 100 determines a candidate of a mobile sales vehicle (referred to as a delivery vehicle) delivering an item included in the order information. Then, based on a current position of a mobile sales vehicle, the current position being indicated by the current position information, and a position of a delivery address indicated by delivery address information included in the order information, the stock management device 100 may specify a mobile sales vehicle arriving earliest at the delivery address, from mobile sales vehicles holding the ordered item, out of the determined candidates. At this time, the stock management device 100 may specify the delivery vehicle in consideration of information indicating whether or not a mobile sales vehicle is open for business, a storefront sales schedule, scheduled traveling route information, or the like. A mobile sales vehicle being open for business represents a state in which a mobile sales vehicle stops at a predetermined location, a luggage carrier is opened, and an item loaded on the mobile sales vehicle is ready to be sold to a customer. For example, the information indicating whether or not a mobile sales vehicle is open for business may be based on a signal indicating that a luggage carrier of the mobile sales vehicle is opened, the signal being transmitted from an on-board device 200 to the stock management device 100. Further, a storefront sales schedule indicates where and when a mobile sales vehicle is scheduled to perform mobile sale. The storefront sales schedule may be stored inside the stock management device 100 or may be transmitted from an on-board device 200. Further, scheduled traveling route information is information indicating a route on which a mobile sales vehicle is scheduled to travel. The scheduled traveling route information may be stored inside the stock management device 100 or may be transmitted from an on-board device 200. Further, the stock management device 100 may specify the delivery vehicle in consideration of a traveling direction of a mobile sales vehicle, road information at that point in time, and the like. The traveling direction of a mobile sales vehicle and the road information may be transmitted from an on-board device 200. The road information may be information indicating a traffic jam or information preset to a road such as one-way traffic. Further, the road information may be transmitted from an external server managing road information. Consequently, a mobile sales vehicle loaded with an on-board device 200 receiving order information becomes a mobile sales vehicle arriving earliest at a delivery address. Accordingly, an ordered item can be delivered more quickly to a customer doing online shopping.

### Third Example Embodiment

Next, a third example embodiment of the present disclosure will be described. A configuration of the on-board device 200 further including a function of recognizing an item of which a customer is considering purchase will be described in the present example embodiment.

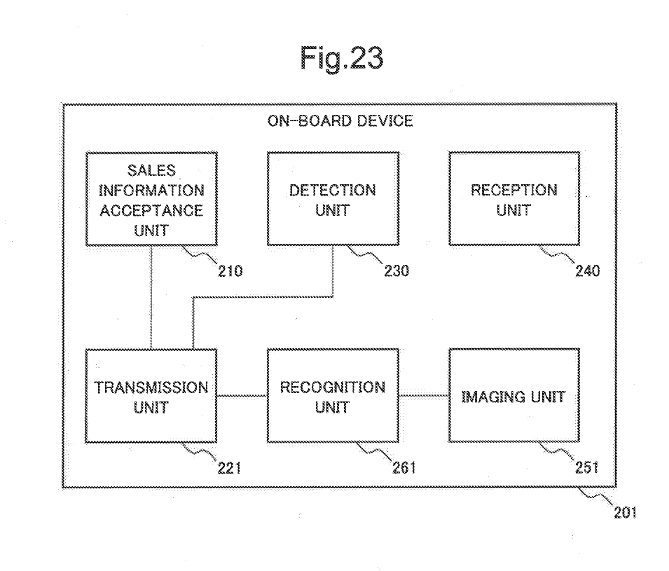

FIG. 23 is a diagram illustrating a functional configuration example of an on-board device 201 according to the present example embodiment. An item sales system 2 including the on-board device 201 includes the on-board device 201 in place of the on-board device 200 in the item sales system 2 illustrated in FIG. 5. Note that, for convenience of description, a component having the same function as that of a component included in the drawing described in the aforementioned second example embodiment is given the same reference sign, and description thereof is omitted.

As illustrated in FIG. 23, the on-board device 201 includes a sales information acceptance unit 210, a transmission unit 221, a detection unit 230, a reception unit 240, an imaging unit 251, and a recognition unit 261.

The imaging unit 251 captures a state of a storefront of a mobile sales vehicle. For example, the imaging unit 251 is implemented with an imaging device such as a surveillance camera or a web camera. The imaging unit 251 provides the captured image being captured to the recognition unit 261. The imaging unit 251 may be implemented with an imaging device separate from the on-board device 201.

The recognition unit 261 recognizes an item of which a customer using a mobile sales vehicle is considering purchase, from a captured image provided from the imaging unit 251. For example, when a customer takes an item in hand, in order to purchase the item, from a shelf displaying items, the recognition unit 261 recognizes the item taken in the customer's hand, from a captured image. Further, when a customer puts an item into a shopping basket, the recognition unit 261 recognizes the item put into the shopping basket by the customer, from a captured image capturing a content of the shopping basket.

The method of recognizing an item by the recognition unit 261 is not limited to the above, and another method may be adopted. For example, when the on-board device 201 includes, in place of the imaging unit 251, a sensor detecting that an item is taken out, the sensor being installed on a shelf displaying items, the recognition unit 261 may recognize the item being taken out, based on a detection result of the sensor.

The recognition unit 261 transmits a recognition result to the transmission unit 221.

In addition to the function of the aforementioned transmission unit 220, the transmission unit 221 transmits, to the stock management device 100, a recognition result provided from the recognition unit 261 as item information indicating an item of which a customer using the mobile sales vehicle is considering purchase.

The stock management device 100 receiving the item information transmits the item information to a customer terminal 300 to which stock information is transmitted. Then, the reception unit 310 in the customer terminal 300 receives the item information from the stock management device 100. The control unit 320 controls to display the display unit 330 in an understandable manner for a customer that an item indicated by the item information is likely to be purchased at the storefront of the mobile sales vehicle.

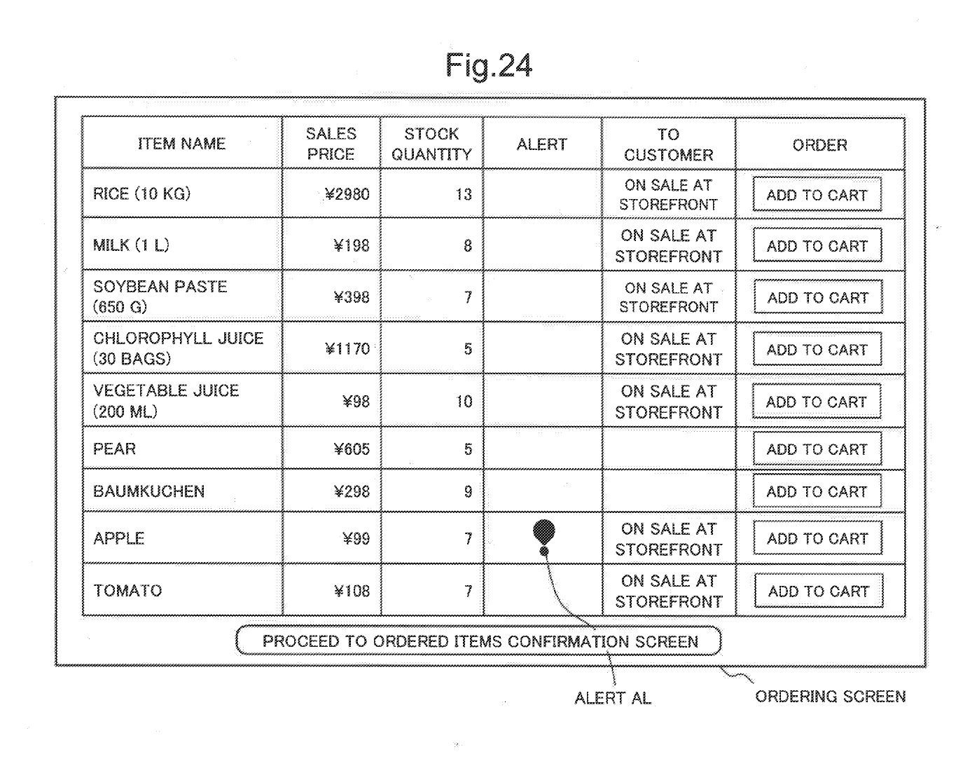

An example of an ordering screen displayed by the display unit 330 will be described with reference to FIG. 24. For example, it is assumed that a customer using a mobile sales vehicle takes an “APPLE” in hand at a storefront of the mobile sales vehicle, and item information includes information indicating the “APPLE”.

In this case, the control unit 320 controls the display unit 330 to display the ordering screen in an understandable manner for a customer that the “APPLE” is likely to be purchased at the storefront of the mobile sales vehicle. For example, as illustrated in FIG. 24, the control unit 320 gets an alert AL displayed in a column “ALERT” associated with “APPLE.”

Consequently, the customer terminal 300 enables the customer to understand that the “APPLE” is likely to be purchased at the storefront of the mobile sales vehicle.

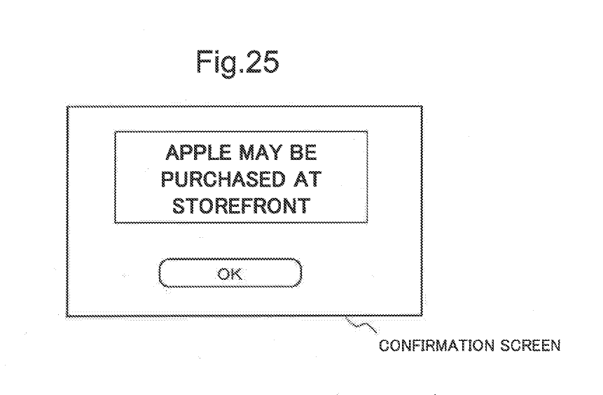

Further, for example, it is assumed that, in a case that item information includes information indicating “APPLE”, a customer doing online shopping puts “APPLE” into a cart on the ordering screen illustrated in FIG. 18. At this time, for example, by displaying a pop-up confirmation screen as illustrated in FIG. 25, the control unit 320 enables the customer to understand that the “APPLE” put into the cart is likely to be purchased at the storefront of the mobile sales vehicle.

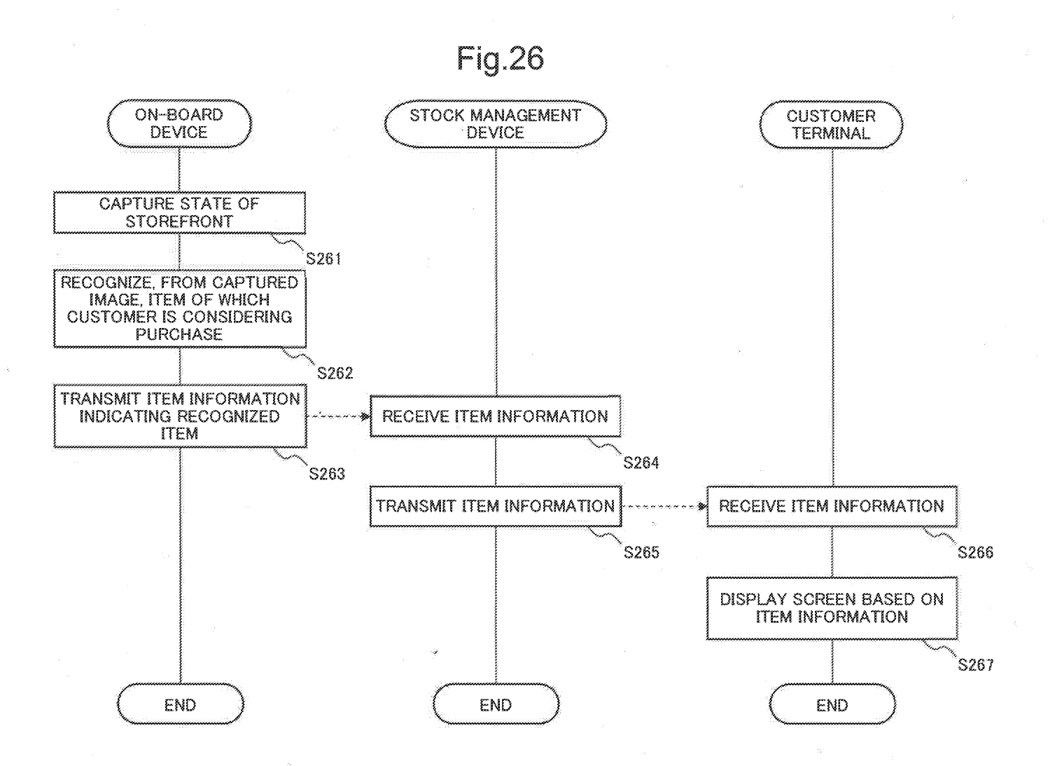

FIG. 26 is a flowchart illustrating an example of a processing flow related to item information in the item sales system 2 according to the present example embodiment. In FIG. 26, processing by an on-board device 201 is described on the left, processing by the stock management device 100 at the center, and processing by a customer terminal 300 on the right; and a broken arrow between the respective processing steps represents a flow of primary information. An information flow is not limited to a direction of an arrow, and for example, an ACK may be transmitted in a direction reverse to the arrow.

First, the imaging unit 251 in an on-board device 201 captures a state of a storefront of a mobile sales vehicle (Step S261). Then, from the captured image provided from the imaging unit 251, the recognition unit 261 recognizes an item of which a customer using the mobile sales vehicle is considering purchase (Step S262). Then, based on the recognition result, the transmission unit 221 transmits item information indicating the recognized item to the stock management device 100 (Step S263). The recognized item is an item of which the customer using the mobile sales vehicle is considering purchase.

Then, the first reception unit 120 in the stock management device 100 receives the item information from the on-board device 201 (Step S264). Then, the first transmission unit 130 transmits the item information to a customer terminal 300 to which stock information is transmitted (Step S265).

The reception unit 310 in the customer terminal 300 receives the item information from the stock management device 100 (Step S266). The control unit 320 causes the display unit 330 to display a screen based on the item information (Step S267). The screen displayed by the display unit 330 is displayed in an understandable manner for a customer that an item indicated by the item information is likely to be purchased at the storefront of the mobile sales vehicle.

Thus, by the control unit 320 controls to display the ordering screen in an understandable manner for a customer that an item indicated by the item information is likely to be purchased at the storefront of the mobile sales vehicle, a customer doing online shopping can more accurately understand sales status of the item at a mobile sales vehicle.

### Modified Example

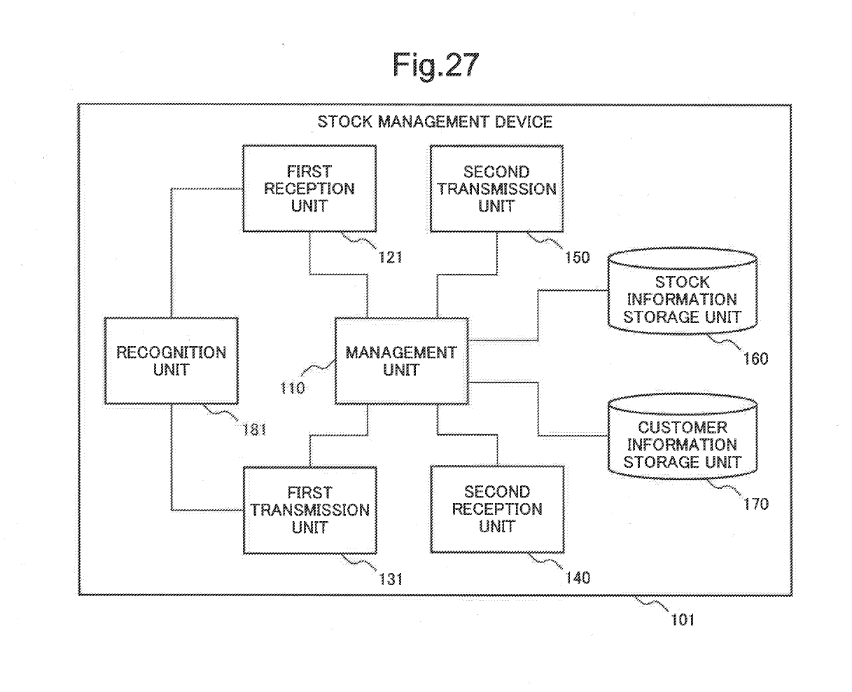

While performing recognition of an item on the on-board device 201 side has been described in the aforementioned third example embodiment, recognition of an item may be performed in the stock management device 100. FIG. 27 is a diagram illustrating a functional configuration example of a stock management device 101 according to this modified example. An item sales system 2 including the stock management device 101 includes the stock management device 101 in place of the stock management device 100 in the item sales system 2 illustrated in FIG. 5. Note that, for convenience of description, a component having the same function as that of a component included in the drawing described in the aforementioned second example embodiment is given the same reference sign, and description thereof is omitted.

As illustrated in FIG. 27, the stock management device 101 according to this modified example includes a management unit 110, a first reception unit 121, a first transmission unit 131, a second reception unit 140, a second transmission unit 150, a stock information storage unit 160, a customer information storage unit 170, and a recognition unit 181.

The first reception unit 121 includes the function of the aforementioned first reception unit 120. Further, the first reception unit 121 receives, from a mobile sales vehicle, a captured image capturing a state of a storefront of the mobile sales vehicle. Then, the first reception unit 121 provides the received captured image to the recognition unit 181.

The recognition unit 181 receives a captured image from the first reception unit 121. The recognition unit 181 recognizes an item of which a customer using a mobile sales vehicle is considering purchase, from the received captured image. The recognition unit 181 provides the recognition result to the first transmission unit 131.

The first transmission unit 131 receives a recognition result from the recognition unit 181. The recognition result includes information about an item of which a customer of a mobile sales vehicle is considering purchase. The first transmission unit 131 transmits, to a customer terminal, item information indicating a recognized item, the item information being included in the recognition result.

Consequently, the control unit 320 in the customer terminal 300 receiving the item information can cause the display unit 330 to display a screen based on the item information. Consequently, the item sales system 2 including the stock management device 101 according to this modified example can also enable a customer doing online shopping to more accurately understand sales status of an item at a mobile sales vehicle, similarly to the third example embodiment.

### About Hardware Configuration

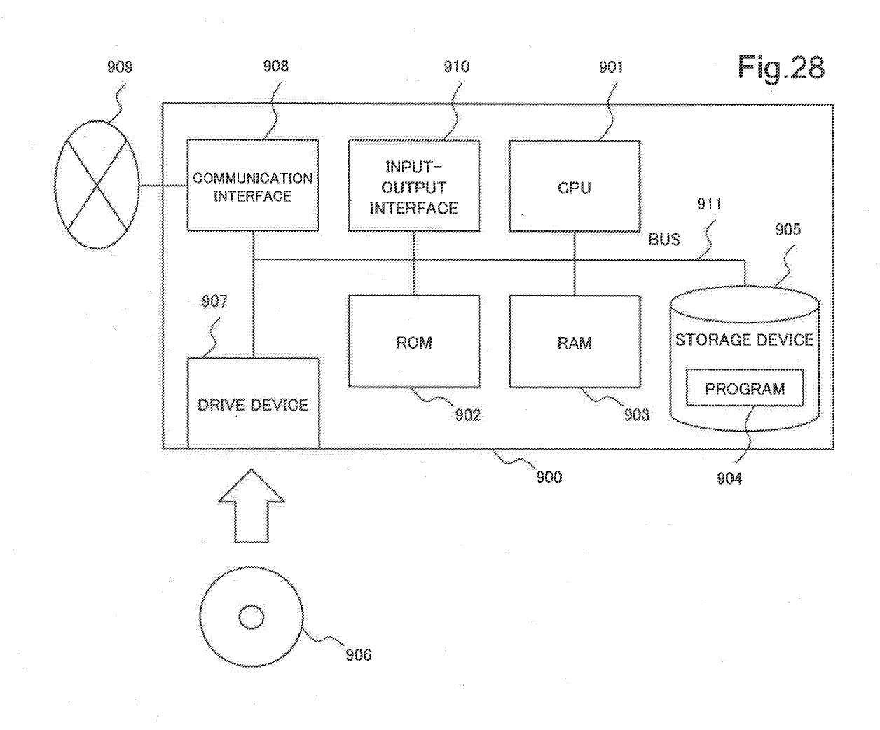

Each component in each of the stock management device, the on-board device, and the customer terminal, according to the respective example embodiments of the present disclosure, represents a functional unit block. For example, each component in each of the stock management device, the on-board device, and the customer terminal is implemented in part or in whole with any combination of an information processing device 900 as illustrated in FIG. 28 and a program. FIG. 28 is a block diagram illustrating a hardware configuration example of the information processing device 900 implementing each component in each of the stock management device, the on-board device, and the customer terminal. As an example, the information processing device 900 includes a configuration as described below.
A central processing unit (CPU) 901
A read only memory (ROM) 902
A random access memory (RAM) 903
A program 904 loaded into the RAM 903
A storage device 905 storing the program 904
A drive device 907 performing reading from and writing to a recording medium 906
A communication interface 908 connected to a communication network 909
An input-output interface 910 performing input and output of data
A bus 911 connecting the respective components

Each component in each of the stock management device, the on-board device, and the customer terminal, according to the respective example embodiments, is implemented by the CPU 901 acquiring and executing the program 904 implementing a function of the component. For example, the program 904 implementing the function of each component in each of the stock management device, the on-board device, and the customer terminal is pre-stored in the storage device 905 or the ROM 902, and is read by the CPU 901 as needed. The program 904 may be provided to the CPU 901 through the communication network 909; or the program may be pre-stored in the recording medium 906, and the drive device 907 may read the program and provide the program to the CPU 901.

There are various modified examples of the implementation method of each of the stock management device, the on-board device, and the customer terminal. For example, each of the stock management device, the on-board device, and the customer terminal may be implemented with any combination of a separate information processing device 900 and a program, for each component. Further, a plurality of components included in each of the stock management device, the on-board device, and the customer terminal may be implemented with any combination of a single information processing device 900 and a program.

Further, each component in each of the stock management device, the on-board device, and the customer terminal is implemented in part or in whole with another general-purpose or dedicated circuit, a processor, or the like, or a combination thereof. The above may be configured with a single chip or may be configured with a plurality of chips connected through a bus.

Each component in each of the stock management device, the on-board device, and the customer terminal may be implemented in part or in whole with a combination of the aforementioned circuit or the like, and a program.

When each component in each of the stock management device, the on-board device, and the customer terminal is implemented in part or in whole with a plurality of information processing devices, circuits, or the like, the plurality of information processing devices, circuits, or the like may be arranged in a concentrated manner or be arranged in a distributed manner. For example, the information processing devices, the circuits, or the like may be implemented in a form of being connected to one another through a communication network, such as a client-server system, a cloud computing system, or the like.

The respective aforementioned example embodiments are preferred example embodiments of the present disclosure, and the scope of the present disclosure is not limited to the respective aforementioned example embodiments; and a person skilled in the art can make example embodiments which include various changes through modifying and substituting the respective aforementioned example embodiments without departing from the spirit and scope of the present disclosure.

The aforementioned example embodiments may also be described in whole or in part as the following supplementary notes but are not limited thereto.

### (Supplementary Note 1)

A stock management device comprising:

management means for managing stock information about stock of an item held by each of a plurality of mobile sales vehicles;

first reception means for receiving, from each of the plurality of mobile sales vehicles, sales information indicating an item sold at a storefront of the mobile sales vehicle and state information indicating a state of the mobile sales vehicle;

first transmission means for transmitting, to a customer terminal, sales state information indicating whether or not the mobile sales vehicle is selling an item at a storefront of the mobile sales vehicle and the stock information, the sales state information being generated based on the state information;

second reception means for receiving, from a customer terminal transmitting the stock information and the sales state information, order information including information about an item ordered based on the stock information and the sales state information; and

second transmission means for transmitting the order information to the mobile sales vehicle holding the ordered item included in the order information, wherein

the management means updates the stock information based on at least one of the sales information and the order information.

### (Supplementary Note 2)

The stock management device according to Supplementary note 1, wherein

the first transmission means transmits, to the customer terminal, item information indicating an item recognized as an item of which a customer using the mobile sales vehicle is considering purchase.

### (Supplementary Note 3)

The stock management device according to Supplementary note 2, wherein

the first reception means receives the item information from the mobile sales vehicle, and

the first transmission means transmits the item information to the customer terminal.

### (Supplementary Note 4)

The stock management device according to Supplementary note 2, wherein

the first reception means receives, from the mobile sales vehicle, a captured image capturing a state of the storefront of the mobile sales vehicle,

the stock management device further comprises recognition means for recognizing, from the captured image, an item of which a customer using the mobile sales vehicle is considering purchase, and

the first transmission means transmits the item information to the customer terminal.

### (Supplementary Note 5)

The stock management device according to any one of Supplementary notes 1 to 4, wherein

the state information is generated based on at least one of a signal indicating a change in movement of or an operating state of the mobile sales vehicle, a signal indicating a change in an engine of the mobile sales vehicle or an operating state of the engine, and a signal indicating whether or not the mobile sales vehicle is open for business.

### (Supplementary Note 6)

A customer terminal comprising:

reception means for receiving, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and

display control means for controlling a display device to display an ordering screen for receiving an order from a customer, the ordering screen being generated based on the stock information and the sales state information.

### (Supplementary Note 7)

The customer terminal according to Supplementary note 6, wherein,

when the sales state information indicates that the mobile sales vehicle is selling an item at the storefront, the display control means gets an item included in the stock information related to the mobile sales vehicle displayed on the ordering screen in a different manner from an item included in stock information related to another mobile sales vehicle.

### (Supplementary Note 8)

The customer terminal according to Supplementary note 6 or 7, wherein

the reception means further receives item information indicating an item of which a customer using the mobile sales vehicle is considering purchase, and

the display control means controls to display the ordering screen in an understandable manner for a customer that an item indicated by the item information is likely to be purchased at the storefront of the mobile sales vehicle.

### (Supplementary Note 9)

The customer terminal according to any one of Supplementary notes 6 to 8, wherein

the state information is generated based on at least one of a signal indicating a change in movement of or an operating state of the mobile sales vehicle, a signal indicating a change in an engine of the mobile sales vehicle or an operating state of the engine, and a signal indicating whether or not the mobile sales vehicle is open for business.

### (Supplementary Note 10)

An item sales system comprising:

a stock management device;

an on-board device being loaded on each of a plurality of mobile sales vehicles and transmitting, to the stock management device, sales information indicating an item sold at a storefront of each of the plurality of mobile sales vehicle and state information indicating a state of the mobile sales vehicle; and

one or more customer terminals, wherein

the stock management device includes:
management means for managing stock information about stock of an item held by each of the plurality of mobile sales vehicles;
first reception means for receiving the sales information and the state information;
first transmission means for transmitting, to the customer terminal, sales state information indicating whether or not the mobile sales vehicle is selling an item at the storefront, the sales state information being generated based on the state information, and the stock information;
second reception means for receiving, from a customer terminal transmitting the stock information and the sales state information, order information including information about an item ordered based on the stock information and the sales state information; and
second transmission means for transmitting the order information to the on-board device on the mobile sales vehicle holding the ordered item included in the order information, wherein

the management means updates the stock information based on at least one of the sales information and the order information.

### (Supplementary Note 11)

The item sales system according to Supplementary note 10, wherein

the first transmission means transmits, to the customer terminal, item information indicating an item recognized as an item of which a customer using the mobile sales vehicle is considering purchase.

### (Supplementary Note 12)

A stock management method comprising:

managing stock information about stock of an item held by each of a plurality of mobile sales vehicles;

receiving, from each of the plurality of mobile sales vehicles, sales information indicating an item sold at a storefront of the mobile sales vehicle;

receiving, from each of the plurality of mobile sales vehicles, state information indicating a state of the mobile sales vehicle;

transmitting, to a customer terminal, sales state information indicating whether or not the mobile sales vehicle is selling an item at the storefront, the sales state information being generated based on the state information, and the stock information;

receiving, from a customer terminal transmitting the stock information and the sales state information, order information including information about an item ordered based on the stock information and the sales state information; and

transmitting the order information to the mobile sales vehicle holding the ordered item included in the order information, wherein

updating the stock information based on at least one of the sales information and the order information.

### (Supplementary Note 13)

The stock management method according to Supplementary note 12, wherein

transmitting, to the customer terminal, item information indicating an item recognized as an item of which a customer using the mobile sales vehicle is considering purchase.

### (Supplementary Note 14)

A display control method comprising:

receiving, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and

controlling a display device to display an ordering screen for receiving an order from a customer, the ordering screen being generated based on the stock information and the sales state information.

### (Supplementary Note 15)

The display control method according to Supplementary note 14, wherein,

when the sales state information indicates that the mobile sales vehicle is selling an item at the storefront, gets an item included in the stock information related to the mobile sales vehicle displayed on the ordering screen in a different manner from an item included in stock information related to another mobile sales vehicle.

### (Supplementary Note 16)

A stock management method in an item sales system including a stock management device, an on-board device being loaded on each of a plurality of mobile sales vehicles, and one or more customer terminals, the stock management method comprising:

managing, by the stock management device, stock information about stock of an item held by each of the plurality of mobile sales vehicles;

transmitting, by the on-board device, to the stock management device, sales information indicating an item sold at a storefront of the mobile sales vehicle loaded with the on-board device and state information indicating a state of the mobile sales vehicle;

receiving, by the stock management device, the sales information;

receiving, by the stock management device, the state information;

transmitting, by the stock management device, to the customer terminal, sales state information indicating whether or not the mobile sales vehicle is selling an item at the storefront, the sales state information being generated based on the state information, and the stock information;

receiving, by the customer terminal, the stock information and the sales state information;

transmitting, by the customer terminal, to the stock management device, order information including information about an item ordered based on the stock information and the sales state information;

receiving, by the stock management device, the order information from the customer terminal;

transmitting, by the stock management device, the order information to the on-board device on the mobile sales vehicle holding the ordered item included in the order information; and

updating, by the stock management device, the stock information based on at least one of the sales information and the order information.

### (Supplementary Note 17)

The stock management method according to Supplementary note 16, wherein

the stock management device transmits, to the customer terminal, item information indicating an item recognized as an item of which a customer using the mobile sales vehicle is considering purchase.

### (Supplementary Note 18)

A computer-readable, non-transitory recording medium recording a program causing a computer to execute:

a process of managing stock information about stock of an item held by each of a plurality of mobile sales vehicles;

a process of receiving, from each of the plurality of mobile sales vehicles, sales information indicating an item sold at a storefront of the mobile sales vehicle;

a process of receiving, from each of the plurality of mobile sales vehicles, state information indicating a state of the mobile sales vehicle;

a process of transmitting, to a customer terminal, sales state information indicating whether or not the mobile sales vehicle is selling an item at the storefront, the sales state information being generated based on the state information, and the stock information;

a process of receiving, from a customer terminal transmitting the stock information and the sales state information, order information including information about an item ordered based on the stock information and the sales state information;

a process of transmitting the order information to the mobile sales vehicle holding the ordered item included in the order information; and

a process of updating the stock information based on at least one of the sales information and the order information.

### (Supplementary Note 19)

The recording medium according to claim 18, wherein storing the program causing a computer to execute:

a process of transmitting, to the customer terminal, item information indicating an item recognized as an item of which a customer using the mobile sales vehicle is considering purchase.

### (Supplementary Note 20)

A computer-readable, non-transitory recording medium recording a program causing a computer to execute:

a process of receiving, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and

a process of controlling a display device to display an ordering screen for receiving an order from a customer, the ordering screen being generated based on the stock information and the sales state information.

### (Supplementary Note 21)

The recording medium according to Supplementary note 20, wherein,

the process of controlling the display device to display the ordering screen is a process of, when the sales state information indicates that the mobile sales vehicle is selling an item at the storefront, getting an item included in the stock information related to the mobile sales vehicle displayed on the ordering screen in a different manner from an item included in stock information related to another mobile sales vehicle.

This application claims priority based on Japanese Patent Application No. 2016-162551 filed on Aug. 23, 2016, the disclosure of which is hereby incorporated by reference thereto in its entirety.

### REFERENCE SIGNS LIST

1 Item sales system
2 Item sales system
10 Stock management device
11 Management unit
12 First reception unit
13 First transmission unit
14 Second reception unit
15 Second transmission unit
20 On-board device
30 Customer terminal
31 Reception unit
32 Display control unit
100 Stock management device
101 Stock management device
110 Management unit
120 First reception unit
121 First reception unit
130 First transmission unit
131 First transmission unit
140 Second reception unit
150 Second transmission unit
160 Stock information storage unit
170 Customer information storage unit
181 Recognition unit
200 On-board device
201 On-board device
210 Sales information acceptance unit
220 Transmission unit
221 Transmission unit
230 Detection unit
240 Reception unit
251 Imaging unit
261 Recognition unit
300 Customer terminal
310 Reception unit
320 Control unit
330 Display unit
340 Acceptance unit
350 Transmission unit

What is claimed is:

1. A stock management device comprising:
a memory storing instructions; and
one or more processors configured to execute the instructions to:
manage stock information about stock of an item held by each of a plurality of mobile sales vehicles;
receive, from each of the plurality of mobile sales vehicles, sales information indicating an item sold at a storefront of the mobile sales vehicle and state information indicating a state of the mobile sales vehicle;
transmit, to a customer terminal, sales state information indicating whether or not the mobile sales vehicle is selling an item at a storefront of the mobile sales vehicle and the stock information, the sales state information being generated based on the state information;
receive, from a customer terminal transmitting the stock information and the sales state information, order information including information about an item ordered based on the stock information and the sales state information; and
transmit the order information to the mobile sales vehicle holding the ordered item included in the order information, wherein
the one or more processors are further configured to execute the instructions to:
update the stock information based on at least one of the sales information and the order information.

2. The stock management device according to claim 1, wherein
the one or more processors are further configured to execute the instructions to:
transmit, to the customer terminal, item information indicating an item recognized as an item of which a customer using the mobile sales vehicle is considering purchase.

3. The stock management device according to claim 2, wherein
the one or more processors are further configured to execute the instructions to:
receive the item information from the mobile sales vehicle, and
transmit the item information to the customer terminal.

4. The stock management device according to claim 2, wherein
the one or more processors are further configured to execute the instructions to:
receive, from the mobile sales vehicle, a captured image capturing a state of the storefront of the mobile sales vehicle;
recognize, from the captured image, an item of which a customer using the mobile sales vehicle is considering purchase, and
transmit the item information to the customer terminal.

5. The stock management device according to claim 1, wherein
the state information is generated based on at least one of a signal indicating a change in movement of or an operating state of the mobile sales vehicle, a signal indicating a change in an engine of the mobile sales vehicle or an operating state of the engine, and a signal indicating whether or not the mobile sales vehicle is open for business.

6. A customer terminal comprising:
a memory storing instructions; and
one or more processors configured to execute the instructions to:
receive, from a stock management device managing stock information about stock of an item held by each of a plurality of mobile sales vehicles, sales state information indicating whether or not the mobile sales vehicle is selling an item at a storefront of the mobile sales vehicle, the sales state information being generated based on state information indicating a state of each of the plurality of mobile sales vehicles, and the stock information; and
control a display device to display an ordering screen for receiving an order from a customer, the ordering screen being generated based on the stock information and the sales state information.

7. The customer terminal according to claim 6, wherein,
the one or more processors are further configured to execute the instructions to:
when the sales state information indicates that the mobile sales vehicle is selling an item at the storefront, get an item included in the stock information related to the mobile sales vehicle displayed on the ordering screen in a different manner from an item included in stock information related to another mobile sales vehicle.

8. The customer terminal according to claim 6, wherein
the one or more processors are further configured to execute the instructions to:
receive item information indicating an item of which a customer using the mobile sales vehicle is considering purchase, and
control to display the ordering screen in an understandable manner for a customer that an item indicated by the item information is likely to be purchased at the storefront of the mobile sales vehicle.

9. The customer terminal according to claim 6, wherein
the state information is generated based on at least one of a signal indicating a change in movement of or an operating state of the mobile sales vehicle, a signal indicating a change in an engine of the mobile sales vehicle or an operating state of the engine, and a signal indicating whether or not the mobile sales vehicle is open for business.

10-11. (canceled)

12. A stock management method comprising:
managing stock information about stock of an item held by each of a plurality of mobile sales vehicles;
receiving, from each of the plurality of mobile sales vehicles, sales information indicating an item sold at a storefront of the mobile sales vehicle;
receiving, from each of the plurality of mobile sales vehicles, state information indicating a state of the mobile sales vehicle;
transmitting, to a customer terminal, sales state information indicating whether or not the mobile sales vehicle is selling an item at the storefront, the sales state information being generated based on the state information, and the stock information;
receiving, from a customer terminal transmitting the stock information and the sales state information, order information including information about an item ordered based on the stock information and the sales state information; and
transmitting the order information to the mobile sales vehicle holding the ordered item included in the order information, wherein
updating the stock information based on at least one of the sales information and the order information.

13. The stock management method according to claim 12, wherein
transmitting, to the customer terminal, item information indicating an item recognized as an item of which a customer using the mobile sales vehicle is considering purchase.

14-21. (canceled)
